(19) United States
(12) Patent Application Publication
(10) Pub. No.: US 2023/0388518 A1
(43) Pub. Date: Nov. 30, 2023

(54) ENCODER, DECODER AND METHODS FOR CODING A PICTURE USING A CONVOLUTIONAL NEURAL NETWORK

(71) Applicant: Fraunhofer-Gesellschaft zur Förderung der angewandten Forschung e.V., München (DE)

(72) Inventors: Jonathan PFAFF, Berlin (DE); Michael SCHÄFER, Berlin (DE); Sophie PIENTKA, Berlin (DE); Heiko SCHWARZ, Berlin (DE); Detlev MARPE, Berlin (DE); Thomas WIEGAND, Berlin (DE)

(21) Appl. No.: 18/448,485

(22) Filed: Aug. 11, 2023

Related U.S. Application Data
(63) Continuation of application No. PCT/EP2022/053447, filed on Feb. 11, 2022.

(30) Foreign Application Priority Data
Feb. 13, 2021 (EP) 21157003.1

(51) Int. Cl. H04N 19/147; H04N 19/172; H04N 19/132; H04N 19/91; G06N 3/0455

(52) U.S. Cl. CPC H04N 19/147; H04N 19/172; G06N 3/0455; H04N 19/91; H04N 19/132

(57) ABSTRACT

A coding concept for encoding a picture uses a multi-layered convolutional neural network for determining a feature representation of the picture, the feature representation comprising first to third partial representations which have mutually different resolutions. Further, an encoder for encoding a picture determines a quantization of the picture using a polynomial function which provides an estimated distortion associated with the quantization.

### CROSS-REFERENCES TO RELATED APPLICATIONS

This application is a continuation of copending International Application No. PCT/EP2022/053447, filed Feb. 11, 2022, which is incorporated herein by reference in its entirety, and additionally claims priority from European Application No. EP 21 157 003.1, filed Feb. 13, 2021, which is incorporated herein by reference in its entirety

Embodiments of the invention relate to encoders for encoding a picture, e.g. a still picture or a picture of a video sequence. Further embodiments of the invention relate to decoders for reconstructing a picture. Further embodiments relate to methods for encoding a picture and to methods for decoding a picture.

Some embodiments of the invention relate to rate-distortion-optimization for deep image compression. Some embodiments relate to an auto-encoder and an auto-decoder for image compression using multi-scale representations of the features. Further embodiments relate to an auto-decoder using an algorithm for determining a quantization of a picture.

### BACKGROUND OF THE INVENTION

The efficient transmission of videos and images has driven an unprecedented surge of telecommunications in the past decade. All coding technologies, applied in different use cases, refer to the same compression task: Given a budget of R* bits for storage, the goal is to transmit the image (or video) with bitrate R≤R* and minimal distortion d. The optimization has an equivalent formulation as

min(d+λR), (1)

where λ is the Lagrange parameter, which depends on R*. Advanced video codecs like HEVC [1, 2] and VVC [3, 4] attack the compression task by a hybrid, block-based approach. The current frame is partitioned into smaller sub-blocks. Divided into these blocks, intra-frame prediction or motion estimation is applied on each block. The resulting prediction residual is transform-coded, using a context-adaptive arithmetic coding engine. Here, the encoder performs a search among several coding options for selecting the block-partition as well as the prediction signal, the transform and the transform coefficient levels; see for examples in [5]. This search is referred to as rate-distortion optimization (RDO): the encoder extensively tests different coding decisions and compares their impact on the Lagrangian cost (1). Algorithms for RDO are crucial to the performance of modern video coding systems and rely on approximations of d and R, disregarding certain interactions between the coding decisions; [6]. Considering the spatial and temporal dependencies inside video signals, the authors of [7] have investigated several techniques for optimal bit allocation. Furthermore, as the quantization has a strong impact on the Lagrangian cost (1), there are several algorithms for selecting the quantization indices of a transform block [8, 9]. In general, the performance of hybrid video encoders heavily relies on such signal-dependent optimizations.

In contrast to the aforementioned block-based hybrid approach, the data-driven training of non-linear transforms for image compression has become a promising prospect; [10]. The authors of use stochastic gradient descent for jointly training an auto-encoder via convolutional neural networks (CNN) with a conditional probability model for its quantized features. Bane et al. have introduced generalized divisive normalizations (GDN) as non-linear activations. The auto-encoder has been enhanced by using a second auto-encoder (called hyper system) for compressing the parameters of the estimated probability density of the features; [13]. The authors have added an auto-regressive model for the probability density of the features and reported compression efficiency which surpasses HEVC in an RGB-setting for still image compression. In [15], the authors have successfully trained a compression system with octave convolutions and features at different scales, similar to the composition of natural images into high and low frequencies; [16].

The introduced concepts, in particular the ones of [10] to [16] such as the auto-encoder concept, GDNs as activation function, the hyper system, the auto-regressive entropy model and the octave convolutions and feature scales may be implemented in embodiments of the present disclosure.

It is a general urge in video and image coding, to improve the tradeoff between a low size of a compressed image and a low distortion of the reconstructed image, as explained with respect to rate R and distortion d in the previous section.

This object is achieved by the subject matter of the independent claims enclosed herewith. Embodiments provided by the independent claims provide a coding concept with a good rate-distortion trade-off.

### SUMMARY

An embodiment may have an apparatus for decoding a picture from a binary representation of the picture, wherein the decoder is configured for deriving a feature representation of the picture from the binary representation using entropy decoding, wherein the feature representation comprises a plurality of partial representations comprising first partial representations, second partial representations and third partial representations, wherein a resolution of the first partial representations is higher than a resolution of the second partial representations, and the resolution of the second partial representations is higher than a resolution of the third partial representations, and using a multi-layered convolutional neural network, CNN, for reconstructing the picture from the feature representation.

Another embodiment may have an apparatus for encoding a picture, configured for using a multi-layered convolutional neural network, CNN, for determining a feature representation of the picture, encoding the feature representation using entropy coding, so as to acquire a binary representation of the picture, wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.

Another embodiment may have a method for decoding a picture from a binary representation of the picture, the method comprising: deriving a feature representation of the picture from the binary representation using entropy decoding, wherein the feature representation comprises a plurality of partial representations comprising first partial representations, second partial representations and third partial representations, wherein a resolution of the first partial representations is higher than a resolution of the second partial representations, and the resolution of the second partial representations is higher than a resolution of the third partial representations, and using a multi-layered convolutional neural network, CNN, for reconstructing the picture from the feature representation.

Another embodiment may have a method for encoding a picture, the method comprising: using a multi-layered convolutional neural network, CNN, for determining a feature representation of the picture, encoding the feature representation using entropy coding, so as to acquire a binary representation of the picture, wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.

Another embodiment may have a bitstream into which a picture is encoded using an apparatus for encoding a picture, configured for using a multi-layered convolutional neural network, CNN, for determining a feature representation of the picture, encoding the feature representation using entropy coding, so as to acquire a binary representation of the picture, wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.

According to embodiments of the invention, a picture is encoded by determining a feature representation of the picture using a multi-layered convolutional neural network, CNN, and by encoding the feature representation.

Embodiments according to a first aspect of the invention rely on the idea of determining a feature representation of a picture to be encoded, which feature representation comprises partial representations of three different resolutions. Encoding of such a feature representation using entropy coding facilitates a good rate-distortion of the encoded picture. In particular, using partial representations of three different resolutions may reduce redundancies in the feature representation, and therefore, this approach may improve the compression performance. Using partial representations of different resolutions allows for using a specific number of features of the feature representation for each of the resolutions, e.g. using more features for encoding higher resolution information of the picture compared to the number of features used for encoding lower resolution information of the picture. In particular, the inventors realized that surprisingly, the dedication of a particular number of features for an intermediate resolution in addition to using particular numbers of features for a higher and for a lower resolution, may, despite an increased implementation effort, result in an improved tradeoff between implementation effort, and a good rate-distortion relation.

According to embodiments of a second aspect of the invention, the feature representation is encoded by determining a quantization of the feature representation. Embodiments of the second aspect rely on the idea of determining the quantization by estimating, for each of candidate quantizations, a rate-distortion measure, and by determining the quantization based on the candidate quantizations. In particular, for estimating the rate-distortion measure, a polynomial function between a quantization error and an estimated distortion is determined. The invention is based on the finding that a polynomial function may provide a precise relation between the quantization error and a distortion related to the quantization error. Using the polynomial function enables an efficient determination of the rate-distortion measure, therefore allowing for testing a high number of candidate quantizations.

A further embodiment exploits the inventors finding, that the polynomial function can give a precise approximation of a contribution of a modified quantized feature of a tested candidate quantization to an approximated distortion of the tested candidate quantization. Further, the inventors found, that the distortion of a candidate quantization may be precisely approximated by means of individual contributions of quantized features. An embodiment of the invention exploits this finding by determining the distortion of a candidate quantization by determining a distortion contribution of a modified quantized feature, which is modified with respect to a predetermined quantization, e.g. a previously tested one, to the approximated distortion of the candidate quantization, which is determined based on the distortion contribution and the distortion of the predetermined quantization. This concept allows, for example, for an efficient, step-wise testing of a high number of candidate quantizations, as, for example, starting from the predetermined quantization, for which the distortion is already determined, determining the distortion contribution from modifying an individual quantized feature using the polynomial function provides a computationally efficient way for determining the approximated distortion of a further candidate quantization, namely the one which differs from the predetermined one in the modified quantized feature.

### BRIEF DESCRIPTION OF THE DRAWINGS

Embodiments of the present invention will be detailed subsequently referring to the appended drawings, in which:

FIG. 1 illustrates an encoder according to an embodiment,

FIG. 2 illustrates the decoder according to an embodiment,

FIG. 3 illustrates an entropy module according to an embodiment,

FIG. 4 illustrates an entropy module according to a further embodiment,

FIG. 5 illustrates an encoder according to another embodiment,

FIG. 6 illustrates the decoder according to another embodiment,

FIG. 7 illustrates an encoding stage CNN according to an embodiment,

FIG. 8 illustrates a decoding stage CNN according to an embodiment,

FIG. 9 illustrates a layer of eight CNN according to an embodiment,

FIG. 10 illustrates a single multi-resolution convolution as downsampling,

FIG. 11 illustrates an encoder according to another embodiment,

FIG. 12 illustrates a quantizer according to an embodiment,

FIG. 13 illustrates a quantizer according to an embodiment,

FIG. 14 illustrates a polynomial function according to an embodiment,

FIG. 15 shows benchmarks according to embodiments,

FIG. 16 illustrates a data stream according to an embodiment.

### DETAILED DESCRIPTION OF THE INVENTION

In the following, embodiments are discussed in detail, however, it should be appreciated that the embodiments provide many applicable concepts that can be embodied in a wide variety of image compression, such as video and still image coding. The specific embodiments discussed are merely illustrative of specific ways to implement and use the present concept, and do not limit the scope of the embodiments. In the following description, a plurality of details is set forth to provide a more thorough explanation of embodiments of the disclosure. However, it will be apparent to one skilled in the art that other embodiments may be practiced without these specific details. In other instances, well-known structures and devices are shown in form of a block diagram rather than in detail in order to avoid obscuring examples described herein. In addition, features of the different embodiments described herein may be combined with each other, unless specifically noted otherwise.

In the following description of embodiments, the same or similar elements or elements that have the same functionality are provided with the same reference sign or are identified with the same name, and a repeated description of elements provided with the same reference number or being identified with the same name is typically omitted. Hence, descriptions provided for elements having the same or similar reference numbers or being identified with the same names are mutually exchangeable or may be applied to one another in the different embodiments.

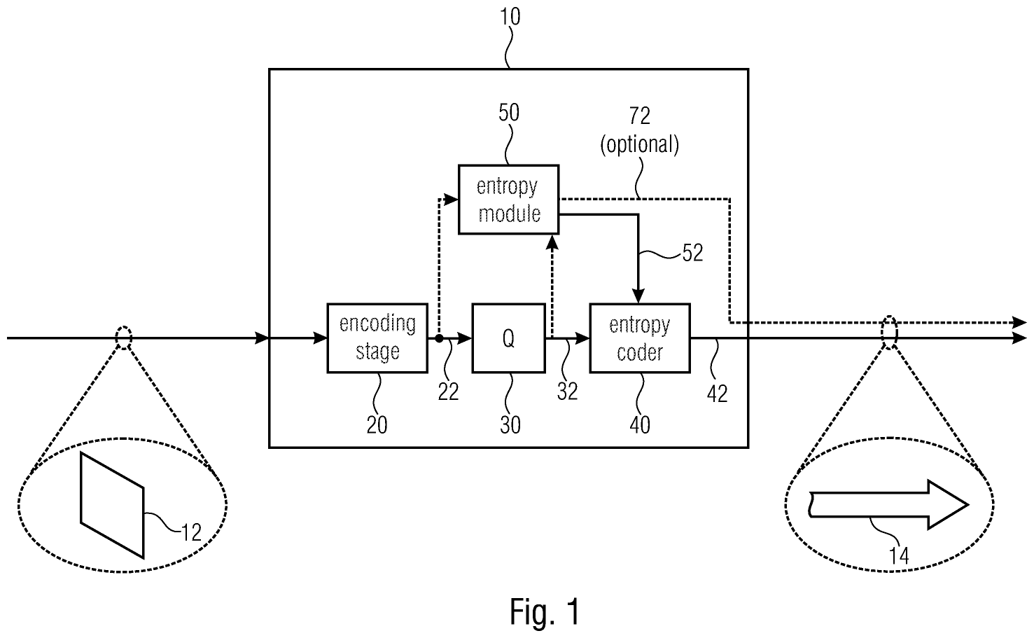

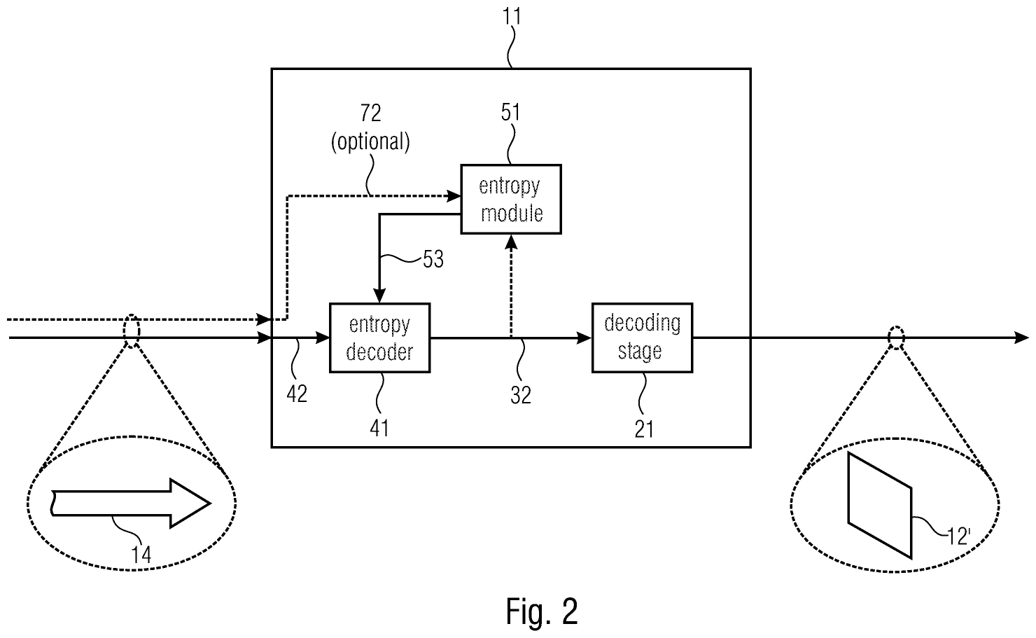

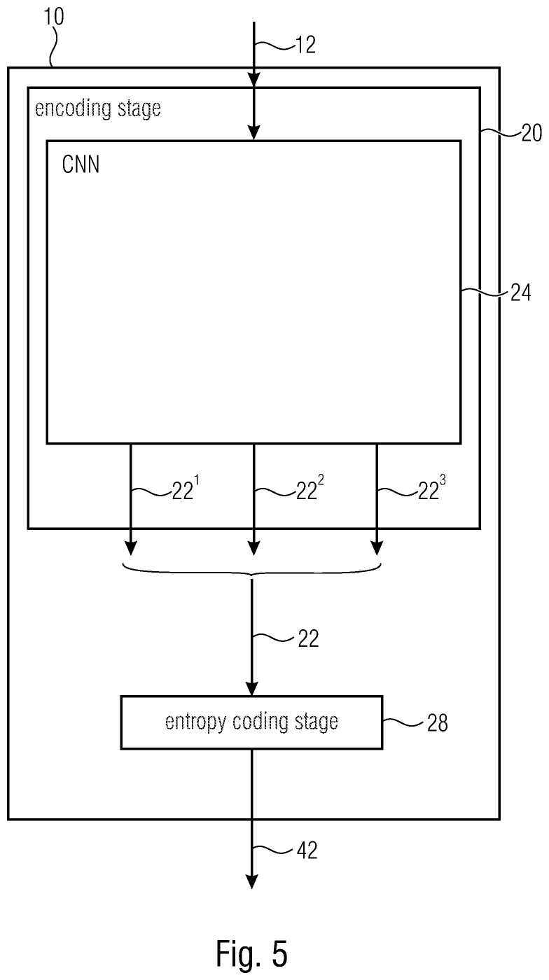

The following description of the figures starts with a presentation of a description of an encoder and a decoder for coding pictures such as still images or pictures of a video in order to form an example for a coding framework into which embodiments of the present invention may be built in. The respective encoder and decoder are described with respect to FIGS. 1 to 4. Thereinafter the description of embodiments of the concept of the present invention is presented along with a description as to how such concepts could be built into the encoder and decoder of FIGS. 1 and 2, respectively, although the embodiments described with the subsequent FIG. 5 and following, may also be used to form encoders and decoders not operating according to the coding framework underlying the encoder and decoder of FIGS. 1 and 2.

### 1. Encoder 10 and Decoder 11 According to FIG. 1 and FIG. 2

FIG. 1 illustrates an apparatus for coding a picture 12, e.g., into a data stream 14. The apparatus, or encoder, is indicated using reference sign 10. FIG. 2 illustrates a corresponding decoder 11, i.e. an apparatus 11 configured for decoding the picture 12′ from the data stream 14, wherein the apostrophe has been used to indicate that the picture 12′ as reconstructed by the decoder 11 deviates from picture 12 originally encoded by apparatus 10 in terms of coding loss, e.g. quantization loss introduced by quantization and/or a reconstruction error. FIG. 1 and FIG. 2 exemplarily describe a coding concept based on trained auto-encoders and auto-decoders trained via artificial neural networks. Although, embodiments of the present application are not restricted to this kind of coding. This is true for other details described with respect to FIGS. 1 and 2, too, as will be outlined hereinafter.

Internally, the encoder 10 may comprise an encoding stage 20 which generates a feature representation 22 on the basis of the picture 12. The feature representation 22 may include a plurality of features being represented by respective values. A number of features of the feature representation 22 may be different from a number of pixel values of pixels of the picture 12. The encoding stage 20 may comprise a neural network, having for example one or more convolutional layers, for determining the feature representation 22. The encoder 10 further comprises a quantizer 30 which quantizes the features of the feature representation 22 to provide a quantized representation 32, or quantization 32, of the picture 12. The quantized representation 32 may be provided to an entropy coder 40. The entropy coder 40 encodes the quantized representation 32 to obtain a binary representation 42 of the picture 12. The binary representation 42 may be provided to data stream 14.

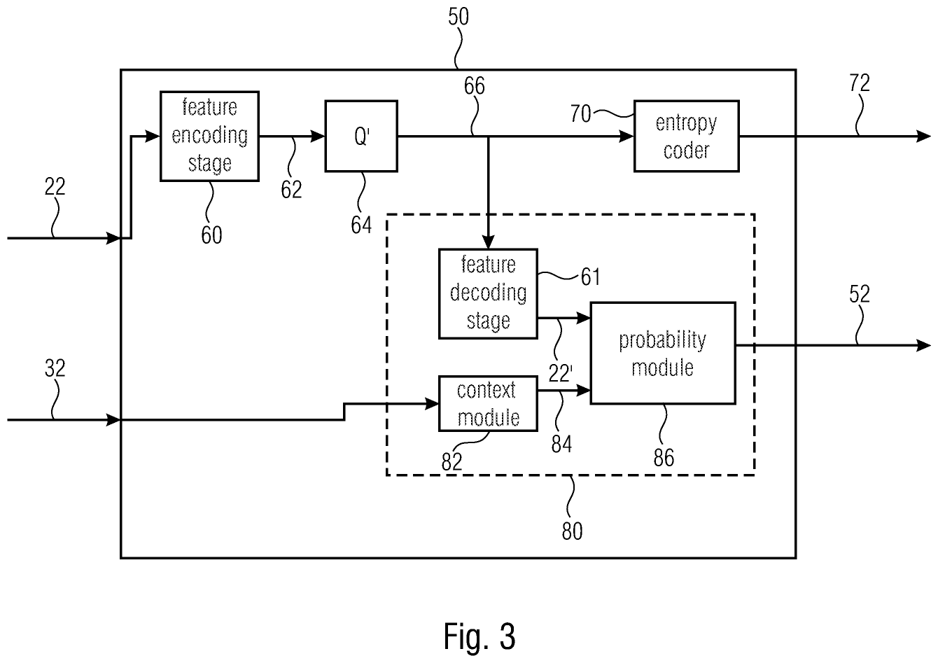

The entropy coder 40 may use a probability model 52 for encoding the quantized representation 32. To this end, entropy coder 40 may apply an encoding order for quantized features of the quantized representation 32. The probability model 52 may indicate a probability for a quantized feature to be currently encoded, wherein the probability may depend on previously encoded quantized features. The probability model 52 may be adaptive. Thus, encoder 10 may further comprise an entropy module 50 configured to provide the probability model 52. For example, the probability may depend on a probability distribution of the previously encoded quantized features. Thus, the entropy module 50 may determine the probability model 52 on the basis of the quantized representation 32, e.g. on the basis of the previously encoded quantized features of the quantized feature representation. In examples, the probability model 52 may further depend on a spatial correlation within the feature representation. Thus, alternatively or additionally to the previously encoded quantized features 32, the entropy module 50 may use the feature representation 22 for determining the probability model 52, e.g. by determining a spatial correlation of features of the feature representation, e.g. as described with respect to FIG. 3. In embodiments, in which the entropy module 50 uses information obtained on the basis of the feature representation 22 for determining the entropy model 52, the entropy module 50 may provide side information 72 in the data stream 14. For example, the entropy module may use information about a spatial correlation of the feature representation 22 for determining the entropy model 52, and may provide said information as side information 72 in the data stream 14.

The decoder 11, as illustrated in FIG. 2 may comprise an entropy decoder 41 configured to receive the binary representation 42 of the picture 12, e.g. as signaled in the data stream 14. The entropy decoder 42 of the decoder 11 may use a probability model 53 for entropy decoding the binary representation 42 so as to derive the quantized representation 32. The decoder 11 comprises a decoding stage 21 configured to generate a reconstructed picture 12′ on the basis of the quantized representations 32. The decoding stage 21 may comprise a neural network having one or more convolutional layers. The convolutional layers may include transposed convolutions, so as to upsample the quantized representation 32 to a target resolution of the reconstructed picture 12′. As mentioned above, the reconstructed picture 12′ may differ from the picture 12 by a distortion, which may include quantization loss, introduced by quantizer 30 of encoder 10, and/or a reconstruction error, which may arise from the fact that decoding stage 21 is not necessarily perfectly inverse to encoding stage 20.

Similar to the entropy coder 40, the entropy decoder 41 may use the probability model 53 for decoding the binary representation 42. The probability model 53 may indicate a probability for a symbol to be currently decoded. The probability model 53 for a currently decoded symbol of the binary representation 42 may correspond to the probability model 51 using which the symbol has been encoded by entropy coder 40. Like the probability model 51, the probability model 53 may be adaptive and may depend on previously decoded symbols of the binary representation 42. The decoder 11 comprises an entropy module 51, which determines the probability model 53. The entropy module 51 may determine the probability model 53 for a quantized feature of the quantized representation 32, which is currently to be decoded, i.e. a currently decoded quantized feature, on the basis of previously decoded quantized features of the quantized feature representation 32. Optionally, the entropy module 51 may receive the side information 72 and use the side information 72 for determining the probability model 53. Thus, the entropy module 51 may rely on information about the feature representation 22 for determining the probability model 53.

The neural networks of encoding stage 20 of the encoder 10 and decoding stage 21 to the decoder 11, and optionally also respective neural networks of the entropy module 50 and the entropy module 51, may be trained using training data so as to determine coefficients of the neural networks. A training objective for training the neural networks may be to improve the trade-off between a distortion of the reconstructed picture 12′ and a rate of data stream 14, comprising the binary representation 42 and optionally the side information 72.

The distortion of the reconstructed picture 12′ may be derived on the basis of a (normed) difference between the picture 12 and the reconstructed picture 12′. An examples of how the neural networks may be trained is given in section 3.

FIG. 3 illustrates an example of the entropy module 50, as it may optionally be implemented in encoder 10. In other examples on the encoder 10 may employ a different entropy module for determining the probability model 52. The entropy module 50 according to FIG. 3 receives the feature representation 22 and/or the quantized feature representation 32.

As described with respect to FIG. 1, the entropy module may determine a probability model for the entropy coding of a currently coded feature of the feature representation. Accordingly, the features of the feature representation 22 may be encoded according to a coding order, also referred to as scan order of the feature representation.

According to an embodiment, the entropy module 50 comprises a feature encoding stage which may generate a feature parametrization 62 on the basis of the feature representation 22. The feature encoding stage 60 may use an artificial neural network having one or more convolutional layers for determining the feature parametrization 62. The feature parameterization may represent a spatial correlation of the feature representation 22. To this end, for example, the feature encoding stage 60 may subject the feature representation 22 to convolutional neural network, e.g. E′ described in section 2. The entropy module 50 may comprise a quantizer 64 which may quantize the feature parametrization 62 so as to obtain a quantized parametrization 66. Entropy coder 70 of the entropy module 50 may entropy code the quantized parametrization 66 to generate the side information 72. For entropy coding the quantized parametrization 66, the entropy coder 70 may optionally apply a probability model which approximates the true probability distribution of the quantized parametrization 66. For example, the entropy coder 70 may apply a parametrized probability model for coding a quantized parameter of the quantized parametrization 66 into the side information 72. For example, the probability model used by entropy coder 70 may depend on previously decoded symbols of the side information 72.

The entropy module 50 further comprises a probability stage 80. The probability stage 80 determines the probability model 52 on the basis of the feature parametrization 66 and on the basis of the quantized representation 32. In particular, the probability stage 80 may consider, for the determination of the probability model 52 for a currently coded quantized feature of the quantized representation 32, previously coded quantized features of the quantized representation 32, as explained with respect to FIG. 1. The probability stage 80 may comprise a context module 82, which may determine, on the basis of previously encoded quantized features of the quantized feature representation 32, a first probability estimation parameter 84 (e.g. θ* of section 2) for the currently coded quantized feature of the quantized feature representation 32. The probability stage 80 may further comprise a feature decoding stage 61 which may generate second probability estimation parameters 22′ on the basis of the feature parametrization 66. For example, the feature decoding stage 61 may determine, for each of the features of the feature representation 22 (and thus for each of quantized features of the quantized representation 32), a second probability estimation parameter (e.g. θ of section 2) which may comprise one or more parameter values for the determination of the probability model 52 for the associated quantized feature. The feature decoding stage 61 may comprise a neural network having one or more convolutional layers. The convolutional layers may include transposed convolutions, so as to upsample the quantized representation 32 to a resolution of the feature representation 22. The probability stage 80 may comprise a probability module 86, which may determine, on the basis of the first probability estimation parameter 84 and the second probability estimation parameter 22′, the probability model 52 for the currently coded quantized feature. In examples, the context module 82 and the probability module 86 may apply a respective artificial neural network for determining the context parameter 84 and the probability model 52, respectively. The probability model 52 may be indicative of a probability distribution for the currently coded quantized feature, e.g. of an expectation value and a deviation referring to a normal distribution, e.g. μ and σ (or σ²) of section 2.

For example, the first probability parameter 84 for the currently coded quantized feature of the quantized feature representation 32 may be determined by context module 82 on the basis of one or more previous quantized features of features that precede the currently coded one in the coding order. Similarly, the second probability estimation parameter 22′ may be determined by the feature decoding stage 61 in dependence on previously coded features. For example, feature encoding stage 60 may determine, for each of the feature of the feature representation 22, e.g. according to the coding order, a parameterized feature of the feature parameterization 62, and quantizer 64 may quantize each of the parameterized feature so as to obtain a respective quantized parameterized feature of the quantized parameterization 66. The feature decoding stage 61 may determine the second probability estimation parameter 22′ for the encoding of the current feature on the basis of one or more quantized parameterized features which have been derived from previous features of the coding order. For example, section 2 describes, by means of index I, an example of how the probability model for the current feature, e.g. the one having index I, may be determined.

It is noted, that according to embodiments, the entropy module 50 does not necessarily use both the feature representation 22 and the quantized feature representation 32 as an input for determining the probability model 52, but may rather use merely one of the two. For example, the probability module 86 may determine the probability model 52 on the basis of one of the first and the second probability estimation parameters, wherein the one used, may nevertheless be determined as described before.

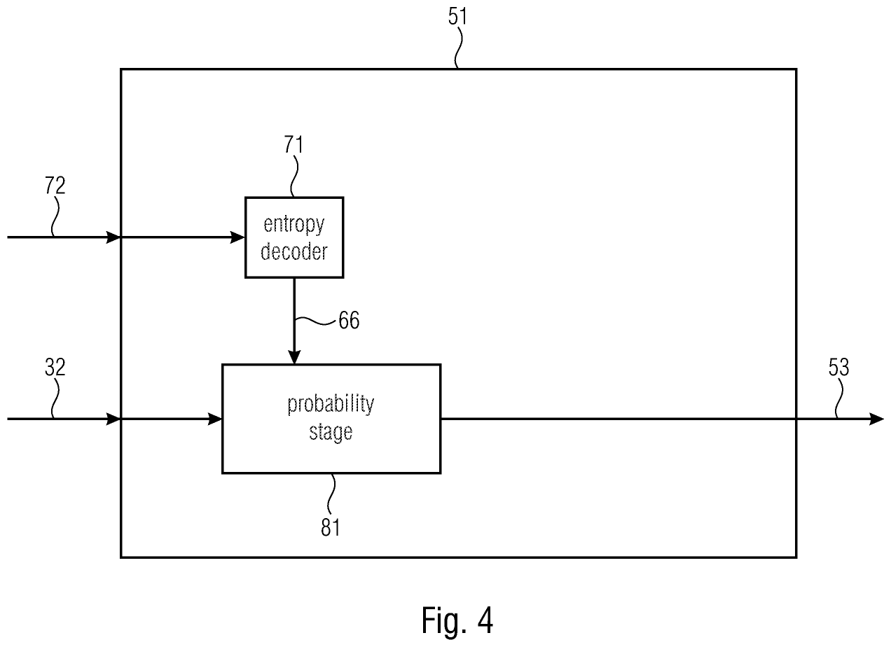

Accordingly, in an embodiment, the entropy module 50 determines the probability model 52 on the basis of previous quantized feature of the quantized feature representation 32, e.g. using a neural network. Optionally, this determination may be performed by means of a first and a second neural network, e.g. a masked neural network followed by a convolutional neural network, e.g. as performed by exemplary implementations of the context module 82 and the probability module 86 illustrated in FIG. 4, however, these neural networks may alternatively also be combined into one neural network.

According to an alternative embodiment, the entropy module 50 determines the probability model 52 on the basis of previous features of the feature representation 22, e.g. using the feature encoding stage 60, the quantizer 65, and the feature decoding stage 61, e.g. as described before. However, according to this embodiment, probability stage 80 may not receive the quantized feature representation 32 as an additional input, but may derive the probability model 52 merely on the basis of the information derived via the feature encoding stage 60, the quantizer 65, and the feature decoding stage 61, e.g. by processing the output of the feature encoding stage 61 by a convolutional neural network, as it may, e.g. be part of the probability module 86. In examples of this embodiment, the feature encoding stage 61 and the probability module 86 may be combined, e.g. the neural networks of the feature encoding stage 61 and the neural network of the probability model 86 may be combined to determine the probability model 52 on the basis of the quantized parameterization 66 using one neural network.

Optionally, the latter two embodiments may be combined, as illustrated in FIG. 4, so that the probability model is determined on both, the first and second probability estimation parameters.

FIG. 4 illustrates an example of a corresponding entropy module 51 as it may be implemented in the decoder 11 of FIG. 2. In other words, the entropy module 51 according to FIG. 4 may be implemented in a decoder 11 corresponding to the encoder 10 having implemented the entropy module 50 of FIG. 3.

As described before, the entropy module 51 may determine a probability model 53 for the entropy decoding of a currently decoded feature of the feature representation 32. Accordingly, the features of the feature representation 32 may be decoded according to a coding order or scan order, e.g. according to which they are encoded into data stream 14.

According to an embodiment, the entropy module 51 according to FIG. 4 may comprise an entropy decoder 71 which may receive the side information 72 and may decode the side information 72 to obtain the quantized parametrization 66. For decoding the side information 72, the entropy coder 70 may optionally apply a probability model, e.g. a probability model which approximates the true probability distribution of the quantized parametrization 66. For example, the entropy decoder 71 may apply a parametrized probability model for decoding a symbol of the side information 72, which probability model may depend on previously decoded symbols of the side information 72.

The entropy module 51 according to FIG. 4 may further comprise a probability stage 81 which may determine the probability model 53 on the basis of the quantized parametrization 66 and based on the quantized representation 32 (i.e. the feature representation 32 on decoder side). The probability stage 81 may correspond to the probability stage 80 of the entropy module 50 of FIG. 3, and the probability model 53 determined for the entropy decoding 41 of one of the features or symbols may accordingly correspond to the probability model 52 determined by the probability stage 80 for the entropy coding 40 of this feature or symbol. That is, the implementation and function of the probability stage 81 may be equivalent to that of the probability stage 80. Although, it is noted, that, in examples, coefficients of neural networks, which may be implemented in the feature decoding stage 61, the context module 82, and the probability module 86, are not necessarily identical, as the encoding and decoding of the binary representation may be trained end-to-end, so that the coefficients of the neural networks may be set individually.

As described with respect to FIG. 3, determining the probability model 53 on the basis of the quantized parametrization 66 may refer to a determination based on quantized parametrized features related to previous features, and determining the probability model 53 on the basis of the feature representation 32 may refer to a determination based on previous features of the feature representation 32.

As described with respect for FIG. 3, according to embodiments, the entropy module 51 may determine the probability model 53 optionally merely on the basis of either of the previous features of the feature representation 32 or the side information 74 comprising the quantized parametrization.

Accordingly, in an embodiment, the probability stage 81 determines the probability model 53 based on previously decoded features of the feature representation, e.g. as described with respect to the probability stage 81, or as described with respect to FIG. 3 for the encoder side. According to this embodiment, the entropy decoder 71 and the transmission of the side information 72 may be omitted.

According to an alternative embodiment, the probability stage 81 determines the probability model 53 based on the quantized parameterization 66, e.g. as described with respect to the probability stage 81, or as described with respect to FIG. 3. According to this embodiment, the probability model may not receive the previous features 32.

Optionally, the latter two embodiments may be combined, as illustrated in FIG. 4, so that the probability model is determined on both, the first and second probability estimation parameters as described with respect to FIG. 4.

Neural networks of the feature encoding stage 60, as well as of the feature decoding stage 61, the context module 82, and the probability module 86 of the probability stage 50 and the probability stage 51 may be trained together with the neural networks of transformer 20 and decoding stage 21, as described with respect to FIG. 1 and FIG. 2.

The feature encoding stage 60 and the feature decoding stage 61 may also be referred to as hyper encoder 60 and hyper decoder 61, respectively. Determining the feature parametrization 66 on the basis of the feature representation 22, may allow for exploiting spatial redundancies in the feature representation 22 in the determination of the probability model 52, 53. Thus, the rate of the data stream 14 may be reduced even though the side information 72 is transmitted in the data stream 14.

In the following, embodiments of the present disclosure are described in detail. All of the herein described embodiments may optionally be implented on the basis of the encoder 10 and the decoder 11 of FIG. 1 and FIG. 2, optionally further implementing the entropy module 50, 51 according to any of the embodiments described with respect to FIG. 3 and FIG. 4. However, the herein described embodiments may alternatively also be implemented independent of the encoder 10 and the decoder 11.

Given the capabilities of massive GPU hardware, there has been a surge of using artificial neural networks (ANN) for still image compression. These compression systems usually consist of convolutional layers and can be considered as non-linear transform coding. Notably, these ANNs are based on an end-to-end approach where the encoder determines a compressed version of the image as features. In contrast to this, existing image and video codecs employ a block-based architecture with signal-dependent encoder optimizations. A basic requirement for designing such optimizations is estimating the impact of the quantization error on the resulting bitrate and distortion. As for non-linear, multi-layered neural networks, this is a difficult problem. Embodiments of the present disclosure provide a well-performant auto-encoder architecture, which may, for example, be used for still image compression. Advantageous embodiments use multi-resolution convolutions so as to represent the compressed features at multiple scales, e.g. according to the scheme described in sections 4 and 5. Further advantageous embodiments implement an algorithm, which tests multiple feature candidates, so as to reduce the Lagrangian cost and to increase or to optimize compression efficiency, as described in sections 6 and 7. The algorithm may avoid multiple network executions by pre-estimating the impact of the quantization on the distortion by a higher-order polynomial. In other words, the algorithm exploits the inventors finding that the impact of small feature changes on the distortion can be estimated by a higher-order polynomial. Section 3 describes a simple RDO algorithm, which employs this estimate for efficiently testing candidates with respect to equation (1) and which significantly improves the compression performance. The multi-resolution convolution and the algorithm for RDO may be combined, which may further improve a rate-distortion trade-off.

Examples of the disclosure may be employed in video coding and may be combined with concepts of High Efficiency Video Coding (HEVC), Versatile Video Coding (VVC), Deep Learning, Auto-Encoder, Rate-Distortion-Optimization.

### 2. Auto-Encoder Architecture

In this section, an implementation of an encoder and a decoder is described in more detail. The encoder and decoder described in this section may optionally be an implementation of encoder 10 as described with respect to FIG. 1 and FIG. 3, and decoder 11 as described with respect to FIG. 2 and FIG. 3.

The presented deep image compression system may be closely related to the auto-encoder architecture in [14]. A neural network E, as it may be implemented in the encoding stage 20 of FIG. 1, is trained to find a suitable representation, e.g. feature representation 22, of the luma-only input image x∈ [symbol] ^{H×W×1}, e.g. picture 12, as features to transmit, and a second network D, as it may be implemented in the decoding stage 21 of FIG. 1, reconstructs the original image from the quantized features \hat{z}, e.g. quantized features of the quantized representation 32, as

z=E(x),\hat{z}=round(z),\hat{x}=D(\hat{z}). (2)

Thus, \hat{x} of the herein used notation may correspond to the reconstructed picture 12′ of FIGS. 1 and 2.

As some of the herein described embodiments focus on an encoder optimization, the description is restrict to luma-only inputs which do not require the weighting of different color channels for computing the bitrate and distortion. Nevertheless, in some embodiments the picture 12 may also comprise chroma channels, which may be processed similarly. Transmitting the quantized features 2 requires a model for the true distribution p_{\hat{z}}, which is unknown. Therefore, a hyper system with a second encoder E′, as it may be implemented in the feature encoding stage 60 of FIG. 3, extracts side information from the features. This information is transmitted and the hyper decoder D′, as it may be implemented in the feature decoding stage 61 of FIG. 4, generates parameters for the entropy model as

y=E′(z),ŷ=round(y),θ=D′(ŷ). (3)

Thus, within the herein used notation, y may correspond to the feature parametrization 62, ŷ may correspond to the quantized parametrization 66, and θ to the second probability estimation parameter 22′. Accordingly, the hyper encoder E′ may be implemented by means of the feature encoding stage 60, and the hyper decoder D′ may be implemented by means of the feature decoding stage 61.

An example for an implementation of the encoder E, decoder D, hyper encoder E′ and hyper decoder D′ is described in section 7.

The hyper parameters are fed into an auto-regressive probability model P_{\tilde{z}} (⋅; θ) during the coding stage of the features. The model employs normal distributions [symbol] (⋅, (μ, σ²)), which has proven to perform well in combination with GDNs as activation; [13]. As described in section 5, GDNs may be employed as activation functions in encoder E and decoder D. We fix a scan order among the features, according to which the quantized features are to be entropy coded into, and map the context of \hat{z}ₗ and the hyper parameters θ to the Gaussian parameters μₗ, σₗ² a via two neural networks

(\hat{z}ₗ₋₁, . . . ,\hat{z}_{l-L}) [symbol] con(\hat{z}ₗ₋₁, . . . ,\hat{z}_{l-L})=θ*ₗ, (5)

(θ*ₗθₗ) [symbol] est(θ*ₗ,θₗ)=(μₗ,σₗ²). (6)

Here, I is an index of a currently coded quantized feature \hat{z}ₗ, L is a number of previously coded quantized features which are considered for the context of \hat{z}ₗ. The auto-regressive part (5) may, for example, use 5×5 masked convolutions. For the case that encoder E and decoder D implement the multi-resolution convolution described in section 4 or in section 5, three versions of the entropy models (5) and (6) may be implemented, as in this case the features consist of coefficients at three different scales. An exemplary implementation of the models con and est of (5) and (6) for a number of C input channels is shown in Table 2. In other words, the encoder and decoder may each implement three of each of the models con and est, one for each scale of coefficients, or feature representations.

TABLE 2
The entropy models: Each row denotes a convolutional layer. The number
of input channels is C ∈ {c₀, c₁, c₂}.

| Comp. | Layer | Kernel | In | Out | Act |
|---|---|---|---|---|---|
| con | Masked | 5 × 5 | C | 2C | None |
| est | Conv | 1 × 1 | 4C | └10C3┘ | ReLU |
| | Conv | 1 × 1 | └10C3┘ | └8C3┘ | ReLU |
| | Conv | 1 × 1 | └8C3┘ | 20 | None |

The estimated probability then becomes

P_{\hat{z}}(\hat{z}ₗ)≈P_{\tilde{z}}(\hat{z}ₗ;θ)=∫_{\hat{z}}_{ₗ}_{-0.5}^{\hat{z}}^{ₗ}^{+0.5} [symbol] (t,(μₗ,σₗ²))dt. (7)

For example, with reference to FIGS. 3 and 4, θ*ₗ may correspond to the first probability estimation parameter 84, μₗ, σₗ², or alternatively P_{\hat{z}}(\hat{z}ₗ) may represent the probability model 52, 53. The context module may implement one or more of the models con, e.g. three in the case that the feature representation comprises representations of three different scales. Similarly, the probability module 86 may implement one or more of the models est, e.g. three in the case that the feature representation comprises representations of three different scales.

Finally, a parametrized probability model P\tilde{y}(⋅,ϕ) approximates the true distribution of the side information, for example as described in [13].

It is noted, that the probability model for a currently coded quantized feature \hat{z}ₗ may alternatively be determined using either the hyper parameter, θₗ, or the context parameter, In other words, according to an embodiment, the probability model is determined using the hyper parameter θₗ. According to this embodiment, the network con may be omitted. According to an alternative embodiment, the probability model is determined using the context parameter determined based on the previously coded quantized features \hat{z}ₗ₋₁, . . . ,\hat{z}_{l-L} by the network con. In this alternative, the hyper encoder/hyper decoder path may be omitted. With respect to equation (6), these embodiments are expressed by the cases

est(θ*ₗ,θₗ)=∀θₗ

bzw.

est(θ*ₗ,θₗ)=θₗ∀θ*ₗ.

The scheme described in this section may be used for implementing both an encoder and a decoder, wherein the implementation of the decoder may follow the correspondences of the encoder 10 and the decoder 11 as described with respect to FIG. 1 and FIG. 2.

A concept for training the neural networks E, E′, D, D′, and the entropy models con, est, ϕ is described in the following section.

### 3. Training of the Neural Networks E, E′, D, D′, and the Entropy Models Con, Est, ϕ

Referring to the encoder 10 and the decoder 11 of FIG. 1 and FIG. 2, as well as to the embodiments described in section 2, neural networks, or models, implemented in the encoding stage 20, e.g. encoder E, in the feature encoding stage 60, e.g. hyper encoder E′, in the feature decoding stage 61, e.g. hyper decoder D′, in the context module 82, e.g. one or more of the models con, and the probability module 86, e.g. one or more of the models est, and in the decoding stage 21, e.g. decoder D, maybe trained by encoding a plurality of pictures 12 into the data stream 14 using encoder 10, and decoding corresponding reconstructed pictures 12′ from the data stream 14 using encoder 11. Coefficients of the neural networks may be adapted according to a training objective, which may be directed towards a trade-off between distortions of the reconstructed pictures 12′ with respect to the pictures 12, as well as a rate, or a size, of the data stream 14, including the binary representations 42 of the pictures 12 as well as the side information 72 in case that the latter is implemented. It is noted, that models which are implemented on both encoder side and decoder side, such as the neural networks of the entropy modules 50 and 51 may in examples be adapted independently from each other during training.

Using the notation from the previous section, the compression task of equation (1) translates into the following, differentiable training objective:

$$min 𝔼 [ \frac{1}{HW} ( d + λ ( R + {R}^{′} ) ) ] , d = ‖ x - D ( \tilde{z} ) {‖}^{2} , \qquad ( 8 )$$

$$R = {\sum }_{l} {\underbrace{- {log}_{2} {P}_{\tilde{z}} ( {\tilde{z}}_{l} ; θ )}}_{:= {R}_{l} ( {\tilde{z}}_{l} ; θ )} , {R}^{′} = {\sum }_{k} - {log}_{2} {P}_{\tilde{y}} ( {\tilde{y}}_{k} ; ϕ ) . \qquad ( 9 )$$

Here, ∥⋅∥ may for example denote the Frobenius norm. For example, for each λ∈{128·2ⁱ, i=0, . . . , 4}, a separate auto-encoder may be been trained. The optimization is performed

via stochastic gradient over luma-only 256×256-patches from the ImageNet data set with batch size 8 and 2500 batches per training epoch. The step size for the Adam optimizer [19] was set as αⱼ=10⁻⁴·1.13^{-j}, where j=0, . . . , 19.

For avoiding zero gradients during gradient computation; [12], the quantization 30 and 64, e.g. the rounding of equation (2) and (3), may be replaced by a summation with noisy training variables for the processing of the training data, wherein [symbol] may represent the equal distribution:

Δ˜ [symbol] (−0.5,0.5),\tilde{z}ₗ=z₁+Δ,\tilde{y}ₖ=yk+Δ, (4)

### 4. Encoder 10 and Decoder 11 According to FIGS. 5 to 9

In this section, embodiments of an encoder 10 and a decoder 11 are described. The encoder 10 and the decoder 11 may optionally correspond to the encoder 10 and the decoder 11 according to FIG. 1 and FIG. 2. For example, in the encoding stage 20 and that the decoding stage 21 of the encoder 10 and the decoder 11 of FIG. 1 and FIG. 2 may be implemented as described in this section. The herein described embodiments of the encoding stage 20 and decoding stage 21 may optionally be combined with the embodiments of the entropy module 50, 51 of FIG. 3 and FIG. 4. However, encoder 10 and decoder 11 according to FIGS. 5 to 9 may also be implemented independently from the details described in sections 1 to 3.

FIG. 5 illustrates an apparatus 10 for encoding a picture 12, also named encoder 10, according to an embodiment. The encoder 10 comprises an encoding stage 20. Encoding stage 20 is configured for determining a feature representation 22 of the picture 12 using a multi-layered convolutional network, CNN, which may be referred to as encoding stage CNN, and which may be referred to as using the reference sign 24. The encoder 10 further comprises an entropy coding stage 28, which is configured for encoding the feature representation 22 using entropy coding, so as to obtain a binary representation 42 of the picture 12. The encoding stage CNN 24 is configured for determining, on the basis of the picture 12, a plurality of partial representations of the feature representation. The plurality of partial representations includes first partial representations 22¹, second partial representations 22², and third partial representations 22³. A resolution of the first partial representations 22¹ is higher than a resolution of the second partial representations 22², and the resolution of the second partial representations 22³ is higher than the resolution of the third partial representations 22³.

For example, for the purpose of entropy coding, the entropy coding stage 28 may comprise an entropy coder, for example entropy coder 40 as described with respect to FIG. 1. The entropy coding stage may further comprise a quantizer, e.g. quantizer 30, for quantizing the feature representation prior to and the entropy coding. For example, the entropy coding stage 28 may correspond to a block of the encoder 10 of FIG. 1, the block comprising quantizer 30 and entropy coder 40.

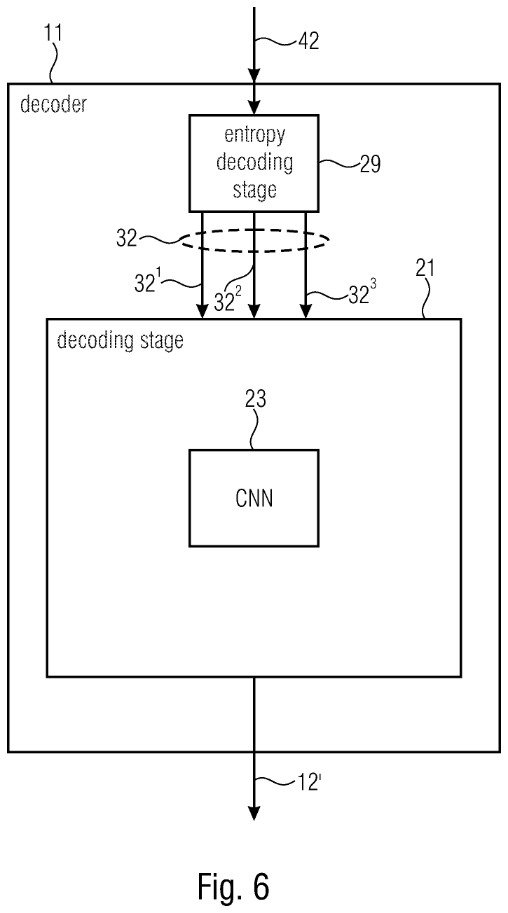

FIG. 6 illustrates an apparatus 11, or decoder 11, for decoding a picture 12′ from a binary representation 42 of the picture 12′. The decoder 11 comprises an entropy decoding stage 29 which is configured for deriving a feature representation 32 of the picture 12′ from the binary representation 42 using entropy decoding. The feature representation 32 comprises a plurality of partial representations, including the first partial representations 32¹, second partial representations 32², and third partial representations 32³. A resolution of the first partial representations 32¹ is higher than the resolution of the second partial representations 32². The resolution of the second partial representations 32² is higher than a resolution of the third partial representations 32³. The decoder 11 further comprises a decoding stage 21 for reconstructing the picture 12′ from the feature representation 32. The decoding stage 21 comprises a multi-layered convolutional neural network, CNN, which may be referred to as decoding stage CNN, and which is referred to using reference sign 23.

For example, for the purpose of entropy decoding, the entropy decoding stage 29 may comprise an entropy decoder, for example entropy decoder 41 as described with respect to FIG. 2. In some embodiments, the entropy decoding stage 29 may correspond to the entropy decoder 41 of FIG. 2.

The following description of this section focuses on embodiments of the encoding stage 20 and the decoding stage 21. While encoding stage 20 of encoder 10 determines the feature representation 22 based on the picture 12, decoding stage 21 of decoder 11 determines the picture 12′ on the basis of the feature representation 32. The feature representation 32 may correspond to the feature representation 22, despite of quantization loss, which may be introduced by a quantizer, which may optionally be part of the entropy coding stage 28.

In other words, described with respect to FIG. 1 and FIG. 2, the feature representation 32 may correspond to the quantized representation 32. The following description of the encoding stage 20 and the decoding stage 21 is focused on the decoder side, and thus is described with respect to the feature representation 32. However, same description may also apply to the encoding stage 20 and the feature representation 22, despite the fact that features of the feature representation 32 may differ from the features of the feature representation 22 by quantization. Similarly, as described with respect to FIG. 1 and FIG. 2, the picture 12′ may correspond to the picture 12 despite of losses, e.g. due to quantization, which may be referred to as a distortion of the picture 12′. In other words, the feature representation 22 may be structurally identical to the quantized feature representation 32, the latter also being referred to as feature representation 32 in the context of the decoder 11. Equivalently, the picture 12 may be structurally identical to the picture 12′. However, in some examples the resolution of the picture 12 may differ from a resolution of the picture 12′.

For example, the picture 12 may be represented by a two-dimensional array of samples, each of the samples having assigned to it, one or more sample values. In some embodiments, each pixel may have a single sample value, e.g. a luma sample. For example, the picture 12 may have a height of H samples and a width of W samples, such having a resolution of H×W samples.

The feature representation 32 may comprise a plurality of features, each of which is associated with one of the plurality of partial representations of the feature representation 22. Each of the partial representations may represent a two-dimensional array of features, so that each feature may be associated with a feature position. Each feature may be represented by a feature value. The partial representations may have a lower resolution than the picture 12, 12′. For example, the decoding stage 21 may obtain the picture 12′ by upsampling the partial representations using transposed convolutions. Equivalently, the encoding stage 20 may determine the partial representations by downsampling the picture 12 using convolutions. For example, a ratio between the resolution of the picture 12′ and the resolution of the first partial representations 32¹ corresponds to a first downsampling factor, a ratio between the resolution of the first partial representations 32¹ and the resolution of the second partial representations 32² corresponds to a second downsampling factor, and a ratio between the resolution of the second partial representations 32² and the resolution of the third partial representations 32² corresponds to a third downsampling factor. In embodiments, the first downsampling factor equal to the second downsampling factor and the thirds downsampling factor, and is equal to 2 or 4.

As the first partial representations 32¹ have a higher resolution than the second partial representations 32² and the third partial representations 32³, they may carry high frequency information of the picture 12, while the second partial representation 32² may carry medium frequency information and the third partial representations 32³ may carry low frequency information.

According to embodiments, a number of the first partial representations 32¹ is at least one half or at least ⅝ or at least three quarters of the total number of the first to third partial representations. By dedicating a great part of the binary representation 42 to a high frequency portion of the picture 12, a particularly good rate-distortion trade-off may be achieved.

In some embodiments, the number of the first partial representations 32 1 is in a range from one half to 15/16 or in a range between five eighths to seven eighths or in a range between three quarters and seven eighths of a total number of the first to third partial representations. These may provide a good balance between high and medium/low frequency portions of the picture 12, so that a good rate-distortion trade-off may be achieved.

Additionally or alternatively to this ratio between the first partial representations 31¹ and the second and third partial representations 31², 31³, a number of the second partial representations 32² may be at least one half or at least five eighths or at least three quarters of a total number of the second and third partial representations 32², 32³.

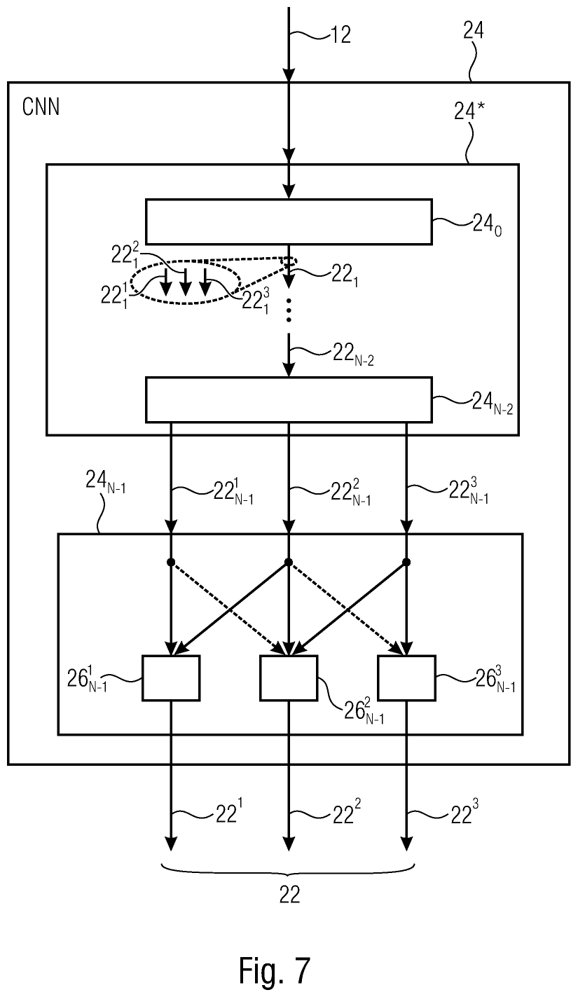

FIG. 7 illustrates an encoding stage CNN 24 according to an embodiment which may optionally be implemented in the encoder 10 according to FIG. 5. The encoding stage CNN 24 comprises a last layer which is referred to as using reference sign 24_{N-1}. The encoding stage CNN 24 may comprise one or more further layers, which are represented by block 24* in FIG. 7. The one or more further layers 24* are configured to provide input representations 24_{N-1} for the last layer on the basis of the picture 12, however, the implementation of block 24* shown in FIG. 7 is optional. The input representations for the last layer 24_{N-1} comprise first input representations 22_{N-1}¹, second input representations 22_{N-1}², and third input representations 22_{N-1}³. The last layer 24_{N-1} is configured for providing a plurality of output representations as the partial representations 22¹, 22², 22³ on the basis of the input representations 22_{N-1}¹, 22_{N-1}², 22_{N-1}³. A resolution of the first input representations 22_{N-1} is higher that a resolution of the second input representations 22_{N-1}, the latter being higher than a resolution of the third input representations 22_{N-1}.

The last layer 24_{N-1} comprises a first module 26_{N-1}¹ which determines the first output representations, that is the first partial representations 22¹, on the basis of the first input representations 22_{N-1}¹. A second module 26_{N-1}² of the last layer 24_{N-1} determines the second output representations 22² on the basis of the first input representations 22_{N-1}¹, the second input representations 22_{N-1}², and the third input representations 22_{N-1}³. A third module 26_{N-1}³ of the last layer 24_{N-1} determines the third output representations 22³ on the basis of the second input representations 22_{N-1}², and the third input representations 22_{N-1}³. That is, the first module 26_{N-1}¹ may use a plurality or all of the first input representations 22_{N-1}¹ and the second input representations 22_{N-1}¹ for determining one of the first output representations 22¹, applying an analog manner to the second module 26_{N-1}² and the third module 26_{N-1}³.

For example, the first to third modules 26_{N-1}¹⁻³ may apply convolutions, followed by non-linear normalizations to their respective input representations.

According to embodiments, the encoding stage CNN 24 comprises a sequence of a number of N−1 layers 24ₙ, with N>1, index n identifying the individual layers, and further comprises an initial layer which may be referred to as using reference sign 24₀. Thus, according to these embodiments, the encoding stage CNN 24 comprises a number of N layers. The last layer 24_{N-1} may be the last layer of the sequence of layers. In other words, referring to FIG. 7, the sequence of layers may comprise layer 24₁ (not shown) to layer 24_{N-1}. Each of the layers of the sequence of layers may receive first, second and third input representations having mutual different resolutions.

For example, for one or more or each of the layers of the sequence of layers 24ₙ, or also, in embodiments in which block 24* is not implemented as shown in FIG. 7, for the last layer, the ratio between the resolution of the first input representations and the resolution of the second input representations may correspond to the ratio between the resolution of the first partial representations 22¹ and the second partial representations 22². Equivalently, for one or more or each of the layers of the sequence of layers 24ₙ, or also, in embodiments in which block 24* is not implemented as shown in FIG. 7, for the last layer, the ratio between the resolution of the second input representations and the resolution of the first input representations may correspond to the ratio between the resolution of the second partial representations 22² and the third partial representations 22³. Same may optionally apply, for one or more or each of the layers of the sequence of layers, or, in embodiments in which block 24* is implemented differently for the last layer, for the ratio between the resolution of the first output representations and the resolution of the second output representations and the ratio between the resolution of the second output representations and the resolution of the third output representations.

For example, for one or more or each of the layers of the sequence of layers 24ₙ, or also, in embodiments in which block 24* is not implemented as shown in FIG. 7, for the last layer, the resolution of the first output representations 22ₙ¹ is lower than the resolution of the first input representations 22ₙ₋₁¹, the resolution of the second output representations 22ₙ² is lower than the resolution of the second input representations 22ₙ₋₁², and the resolution of the third output representations 22ₙ³ as to whether the resolution of the third input representations 22ₙ₋₁³. In other words, each of the layers may determine its output representations by downsampling its input representations, using convolutions with downsampling rate greater one.

In advantageous embodiments, for one or more or each of the layers of the sequence of layers 24ₙ, or also, in embodiments in which block 24* is not implemented as shown in FIG. 7, for the last layer, the number of first output representations 22ₙ¹ equals the number of the first input representations 22ₙ₋₁¹, the number of the second output representations 22ₙ² equals the number of the second input representations 22ₙ₋₁², and the number of third output representations 22ₙ¹ equals the number of the third input representations 22ₙ₋₁³. However, in other embodiments, the ratio between the number of input representations and the number of output representations may be different.

According to embodiments, each of the layers of the sequence of layers determines its output representations based on its input representations as described with respect to the last layer 24_{N-1}. However, coefficients of applied transformations for determining the output representations may be mutual different between the layers of the sequence of layers.

The initial layer 24₀ determines the input representations 22₁ for the first layer 24₁, the input representations 22₁ comprising first input representations 22₁¹, second input representations 22₁² and third input representations 22₁³. The initial layer 24₀ determines the input representations 22₁ by applying convolutions to the picture 12.

According to embodiment, the sampling rate and the structure of the initial layer may be adapted for a structure of the picture 12. E.g., the picture may comprise one or more channels (i.e. two-dimensional sample arrays), e.g. a luma channel and/or one or more chroma channels, which may have mutually equal resolution, or, in particular for some chroma formats, may have different resolutions. Thus, the initial layer may apply a respective sequence of one or more convolutions to each of the channels to determine the first to third input representations for the first layer.

In advantageous embodiments, e.g. for cases in which the picture comprises one or more channels of equal resolution, the initial layer 24₀ determines, as indicated in FIG. 7 as optional feature using dashed lines, the first input representations 22₁¹ by applying convolutions having a downsampling rate greater one to the picture, i.e. a respective convolution for each of the first input representations 22₁¹. According to these advantageous embodiments, the initial layer 24₀ determines each of the second input representations 22₁² by applying convolutions having a downsampling rate greater one to each of the first input representations 22₁¹ to obtain downsampled first input representations, and by superposing the downsampled first input representations to obtain the second input representation. Further, according to these advantageous embodiments, the initial layer 24₀ determines each of the third input representations 22₁³ by applying convolutions having a downsampling rate greater than one to each of the second input representations 22₁³ to obtain downsampled second input representations, and by superposing the downsampled second input representations to obtain the third input representation. Optionally, non-linear activation functions may be applied to the results of each of the convolutions to determine the first, second, and third input representations 22₁¹⁻³.

In general, a superposition of a plurality of input representations may refer to a representation (referred to as superposition), each feature of which is obtained by a combination of all features of the input representations which features are associated with a feature position which corresponds to a feature position of the feature within the superposition. The combination may be a sum or a weighed sum, wherein some coefficients may optionally be zero, so that not necessarily all of said features contribute to the superposition.

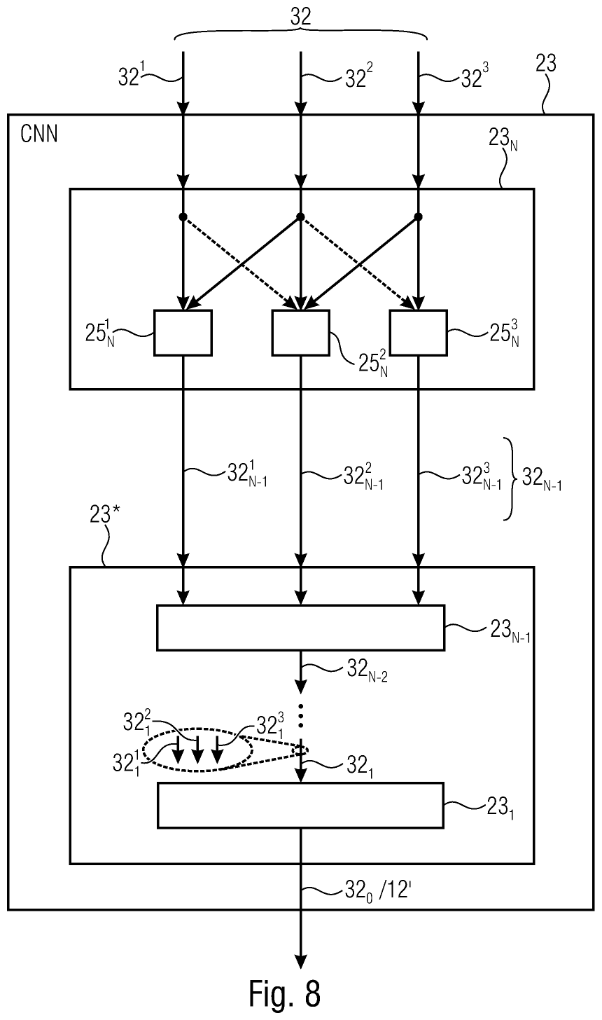

FIG. 8 illustrates a decoding stage CNN 23 according to an embodiment which may optionally be implemented in the decoder 11 according to FIG. 6. The decoding stage CNN 23 comprises a first layer which is referred to as using reference sign 23_{N}. The first layer 23_{N} is configured for receiving the partial representations 32¹, 32², 32³, as input representations. The first layer 23N determines a plurality of output representations 32_{N-1}. The output representations 32_{N-1} include first output representations 32_{N-1}¹, second output representations 32_{N-1}², and third output representations 32_{N-1}³. A resolution of the first output representations 32_{N-1}¹ is higher than a resolution of the second output representations 32_{N-1}², the latter being higher than a resolution of the third output representations 32_{N-1}³.

The first layer 23_{N} comprises a first module 25_{N}¹, a second module 25_{N}² and a third module 25_{N}³. The first module 25_{N}¹ determines the first output representations 32_{N-1}¹ on the basis of the first input representations 32¹ and the second input representations 32². The second module 25_{N}² determines the second output representations 32_{N-1}² on the basis of the first to third input representations 32¹⁻³. The third module 25_{N}³ determines the third output representations 32_{N-1}³ on the basis of the second and third input representations 32²⁻³. In other words, the first module 25_{N}¹ may use a plurality or all of the first and second input representations 32¹⁻² for determining one of the first output representations 32_{N-1}¹, which applies in an analog manner to the second module 25_{N}² and the third module 25_{N}³.

The output representations 32_{N-1} of the first layer 23_{N} may have a lower resolution than the input representations 32¹⁻³ of the first layer 23_{N} in a sense that the first output representations have a lower resolution than the first input representations, the second output representations have a lower resolution than the second input representations, and the third output representations have a lower resolution than the third input representations. For example, the resolution of the first to third output representations may be lower than the resolution of the first to third input representations by a downsampling factor of two or four, respectively.

For example, the first to third modules 25_{N}¹⁻³ may use transposed convolutions and/or convolutions, each of which may optionally be followed by a non-linear normalization, for determining their respective output representations on the basis of the respective input representations.

The decoding stage CNN 23 may comprise one or more further layers, which are represented by block 23* in FIG. 8. The one or more further layers 23* are configured to provide the picture 12′ on the basis of the first to third output representations 32_{N-1}¹⁻³ of the first layer 23_{N}. The implementation of the further layers 23* shown in FIG. 8 is optional.

According to embodiments, the decoding stage CNN comprises a sequence of a number of N−1 layers 23ₙ, with N>1, index n identifying the individual layers, and further comprises a final layer which may be referred to using reference sign 23₁. Thus, according to these embodiments, the decoding stage CNN 23 comprises a number of N layers. The first layer 23_{N} may be the first layer of the sequence of layers. In other words, referring to FIG. 8 the sequence of layers may comprise layer 23_{N} to layer 23₂. Each of the layers of the sequence of layers may receive first, second and third input representations having mutual different resolutions.

According to embodiments, the relations between the resolutions of the first to third input representations and between the resolutions of the first to third output representations of the layers 23ₙ of the sequence of layers of the encoding stage CNN 24 may optionally be implemented as described with respect to layers 22ₙ of the decoding stage CNN 23. Same applies for the number of input representations and output representations of the layers of the sequence of layers. Note that the order of the index for the layers is revered between the decoding stage CNN 23 and the encoding stage CNN 24.

According to embodiments, each of the layers of the sequence of layers determines its output representations based on its input representations as described with respect to the first layer 23_{N}. However, coefficients of applied transformations for determining the output representations may be mutual different between the layers of the sequence of layers.

The final layer 23₁ determines the picture 12′ on the basis of the output representations 32₁ of the last layer 23₂ of the sequence of layers, being input representations 32₁ of the final layer 23₁. The output representations 32₁ may comprise, as indicated in FIG. 8 as optional feature using dashed lines, first output representations 32₁¹, second output representations 32₁³, and third output representations 32₁³. The final layer 23₁ determines the picture 12′ by upsampling the first to third output representations 32₁¹⁻³ tray target resolution of the picture 12′, and combining the upsampled first to third output representations 32₁¹⁻³. As described with respect to the initial layer 24₀, the picture 12′ may comprise one or more channels, which do not necessarily have same resolutions. Thus, a number of transposed convolutions or upsampling rates of transposed convolutions applied by the final layer may vary beyond the output representations, depending on the channel of the picture, to which a respective output representation belongs.

According to an advantageous embodiment, the final layer 23₁ applies transposed convolutions having an upsampling rate greater than one to its third input representations 32₁³ to obtain third representations. That is, the final layer 23₁ may determine each of the third representations by applying respective transposed convolutions having an upsampling rate greater than one to each of the third input representations 32₁¹ to obtain the third representation. Further, the final layer 23₁ may determine second representations by superposition of upsampled third representations and upsampled second representations. The final layer 23₁ may determine each of the upsampled third representations by applying respective transposed convolutions having an upsampling rate greater than one to each of the third representations. The final layer 23₁ may determine each of the upsampled second representations by applying respective transposed convolutions having an upsampling rate greater than one to each of the second input representations 32₁². Finally, the final layer 23₁ may determine the picture 12′ by superposition of further upsampled second representations and upsampled first representations. The final layer 23₁ may determine each of the further upsampled second representations by applying respective transposed convolutions having an upsampling rate greater than one to each of the second representations. The final layer 23₁ may determine each of the upsampled first representations by applying respective transposed convolutions having an upsampling rate greater than one to each of the first input representations 32₁¹.

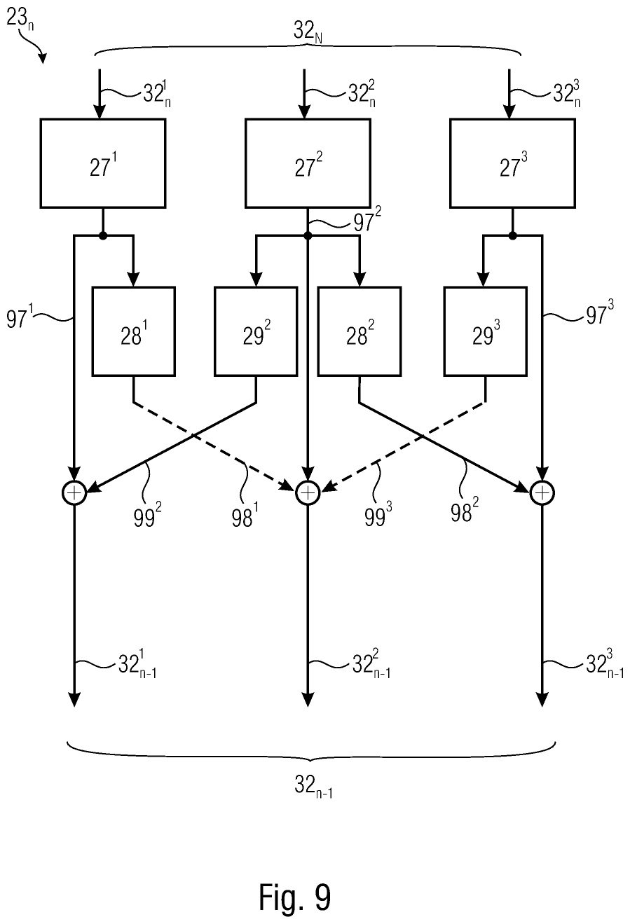

According to an advantageous embodiment, each of the layers 23_{N} to 23₂ may be implemented according to the exemplary embodiment described with respect to FIG. 9

FIG. 9 shows a block diagram of a layer 23ₙ according to an advantageous embodiment. Layer 23ₙ determines output representations 32ₙ₋₁ on the basis of input representations 32ₙ. For example, the layer 23ₙ may be an example of each of the layers of the sequence of layers of the decoding stage CNN 23 of FIG. 8, wherein the index n making the range from 2 to N.

The layer 23ₙ comprises a first transposed convolution module 27¹, a second transposed convolution module 27² and a third transposed convolution module 27³. Transposed convolutions the front by the first to third transposed convolutions 27¹⁻³ may have a common upsampling rate. The layer 23ₙ further comprises a first cross-component convolutions module 28¹ and a second cross component convolutions module 28². The layer 23ₙ further comprises a second cross component transposed convolution module 29² in the third cross component transposed convolution module 29³.

The layer 23ₙ is configured for determining each of the first output representations 32ₙ₋₁¹ by superposing a plurality of first upsampled representations 97¹ provided by the first transposed convolution module 27¹ and a plurality of upsampled second upsampled representations 99² provided by the second cross component transposed convolution module 29². Each of the plurality of first upsampled representations 97¹ for the determination of the first output representation is determined by the first transposed convolution module 27¹ by superposing the results of transposed convolutions of each of the first input representations 32ₙ¹. The first upsampled representations 97¹ have a higher resolution than the first input representations 32ₙ¹. Further, each of the plurality of upsampled second upsampled representations 99² for determining the first output representation is determined by the second cross component transposed convolution module 29² by applying a transposed convolution to each of a respective plurality of second upsampled representations 97². Each of the respective plurality of second upsampled representations 97² for the determination of the upsampled second upsampled representation is determined by the second transposed convolution module 27² by superposing the results of transposed convolutions of each of the second input representations 32ₙ². The transposed convolutions applied by the second cross component transposed convolution module 29² have an upsampling rate which may correspond to the ratio between the resolutions of the first upsampled representations 97¹ and the second upsampled representations 97², which may correspond to the ratio between the resolutions of the first input representations 32ₙ¹ and the second input representations 32ₙ².

The layer 23ₙ is configured for determining each of the second output representations 32ₙ₋₁² by superposing a plurality of second upsampled representations 97² provided by the second transposed convolution module 27² and a plurality of downsampled first upsampled representations 98¹ provided by the first cross component convolution module 28¹, and a plurality of upsampled third upsampled representations 99³. Each of the plurality of second upsampled representations 97² for the determination of the second output representation is determined by the second transposed convolution module 27² by superposing the results of transposed convolutions of each of the second input representations 32ₙ². The second upsampled representations 97² have a higher resolution than the second input representations 32ₙ². Further, each of the plurality of downsampled first upsampled representations 98¹ for determining the second output representation is determined by the first cross component convolution module 28¹ by applying a convolution to each of a respective plurality of first upsampled representations 97¹. Each of the respective plurality of first upsampled representations 97¹ for the determination of the downsampled first upsampled representation is determined by the first transposed convolution module 27¹ by superposing the results of transposed convolutions of each of the first input representations 32ₙ¹. The convolutions applied by the first cross component convolution module 28¹ have a downsampling rate which may correspond to the upsampling rate of the transposed convolutions applied by the second cross component transposed convolution module 29². Further, each of the plurality of upsampled third upsampled representations 99³ for the determination of the second output representation is determined by the third cross component transposed convolution module 29³ by applying a respective transposed convolution to each of a respective plurality of third upsampled representations 97³. Each of the respective plurality of third upsampled representations 97³ for the determination of the upsampled third upsampled representation is determined by the first transposed convolution module 27³ by superposing the results of transposed convolutions of each of the input representations 32ₙ³. The transposed convolutions applied by the third cross component transposed convolution module 29³ have an upsampling rate which may correspond to the ratio between the resolutions of the second upsampled representations 97¹ and the third upsampled representations 97², which may correspond to the ratio between the resolutions of the second input representations 32ₙ¹ and the third input representations 32ₙ².

The layer 23ₙ is configured for determining each of the third output representations 32ₙ₋₁³ by superposing a plurality of third upsampled representations 97³, and a plurality of downsampled second upsampled representations 98². Each of the plurality of third upsampled representations 97³ for the determination of the third output representation is determined by the third transposed convolution module 27³ by superposing the results of transposed convolutions of each of the third input representations 32ₙ³. The third upsampled representations 97³ have a higher resolution than the third input representations 32ₙ³. Further, each of the plurality of downsampled second upsampled representations 98² for determining the third output representation is determined by the second cross component convolution module 28² by applying a convolution to each of a respective plurality of second upsampled representations 97². Each of the respective plurality of second upsampled representations 97² for the determination of the downsampled second upsampled representation is determined by the second transposed convolution module 27² by superposing the results of transposed convolutions of each of the second input representations 32ₙ¹. The convolutions applied by the second cross component convolution module 28² have a downsampling rate which may correspond to the upsampling rate of the transposed convolutions applied by the third cross component transposed convolution module 29³

Each of the transposed convolutions and the convolutions may sample the representation to which it is applied using a kernel. In examples, the kernel is quadratic with a number of k samples in each of two dimensions of the (transposed) convolution. That is, the (transposed) convolution may use a k×k kernel. Each sample of the kernel may have a respective coefficient, e.g. used for weighting the feature of the representation to which the sample of the kernel is applied at a specific position of the kernel. The coefficients of the kernel of the (transposed) convolution may be mutually different and may result from training of the CNN. Further, the coefficients of the kernels of the respective (transposed) convolutions applied by one of the (transposed) convolution modules 27¹⁻³, 28¹⁻², 29²⁻³ to the plurality of representations which are input to the (transposed) convolution module may be mutually different. That is, by example of the first cross component convolution module 28¹, the kernels of the convolutions applied to the plurality of first upsampled representations 97¹ for the determination of one of the downsampled first upsampled representations 98¹ may have mutually different coefficients. Same may apply to all of the (transposed) convolution modules 27¹⁻³, 28¹⁻², 29²⁻³.

Optionally, a nonlinear normalizations function, or more general in activation function, may be applied to the result of each of the convolutions and transposed convolutions. For example, a GDN function may be used as nonlinear normalizations function, for example as described in the introductory part of the description.

The scheme of layer 23ₙ may equivalently be applied as implementation of the last layer 24_{N-1} or for each layer 24ₙ of the sequence of layers of the encoding stage CNN 24, the first to third input representations 32ₙ¹⁻³ being replaced by the first to third input representations 22ₙ¹⁻³ of the respective layer 24ₙ, and the first to third output representations 32ₙ₋₁¹⁻³ being replaced by the first to third output representations 22ₙ₊₁¹⁻³ of the respective layer. In case of the encoding stage CNN 24, the first to third transposed convolution modules 27¹⁻³ are replaced by first to third convolution modules, which differs from the first to third transposed convolution modules 27¹⁻³ in that the transposed convolutions are replaced by convolutions performing a downsampling instead of an upsampling. It is noted, that the orders of the indices of the layers of the encoding stage CNN 24 and the decoding stage CNN 23 are inverse to each other.

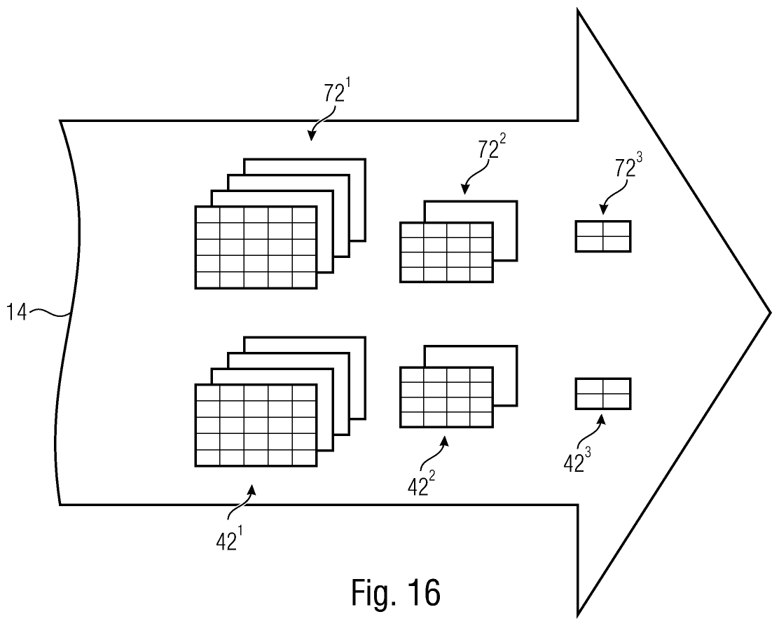

FIG. 16 illustrates an example of the data stream 14 as it may be generated by examples of the encoder 10 and be received by examples of the decoder 11. The data stream 14 according to FIG. 16 comprises, as partial representations of the binary representation 42, first binary representations 42¹ representing the first quantized representations 32¹, second binary representations 42² representing the second quantized representations 32², and third binary representations 42³ representing the third quantized representations 32³. As the binary representations represent the quantized representations 32, they are illustrated in form of two-dimensional arrays, although the data stream 14 may comprise the binary representation 42 in form of a sequence of bits. Same applies to the side information 72, which is optionally part of the data stream 14, in which may comprise a first partial side information 72¹, second partial side information 72², and third partial side information 72³.

### 5. Multi-Resolution Auto-Encoder and Auto-Decoder

This section describes an embodiment of an auto-encoder E and a auto-decoder D, as they may be implemented within the auto-encoder architecture and the auto-decoder architecture described in section 2. The herein described auto-encoder E and the auto-decoder D may be specific embodiments of the encoding stage 20 and the decoding stage 21 as implemented in the encoder 10 and the decoder 20 of FIG. 1 and FIG. 2, optionally but advantageously in combination with the implementations of the entropy module 50, 51 of FIG. 3 and FIG. 4. In particular, the auto-encoder E and the auto-decoder D described herein may optionally be examples of the encoding stage CNN 24 of FIG. 5 and FIG. 7 and the decoding stage CNN 23 of FIG. 6 and FIG. 8, respectively. The auto-encoder E and the auto-decoder D may be examples of the encoding stage CNN 24 and the decoding stage CNN 23 implemented in accordance with FIG. 9. Thus, details described within this section may be examples for implementing the encoding stage CNN 24 and the decoding stage CNN 23 as described with respect to FIG. 9. However, it should be noted, that the herein described auto-encoder E and the auto-decoder D may be implemented independently from the details described in section 4. The notation used as in this section is accordance with section 2, which holds in particular for the relation between the notation of section 2 and features of FIGS. 1 to 4.

Natural images are usually composed of high and low frequency parts, which can be exploited for image compression purposes. In particular, having channels at different resolutions might help to remove redundancies in the feature representation. The encoder network

$$E : {ℝ}^{W \times H \times 1} \to {ℝ}^{W \times H \times {c}_{0}} ⊕ {ℝ}^{\frac{w}{2} \times \frac{h}{2} \times {c}_{1}} ⊕ {ℝ}^{\frac{w}{4} \times \frac{h}{4} \times {c}_{2}}$$

consists of multi-resolution downsampling convolutions as follows

E=E_{N-1}∘. . . ∘E₀

where the features are separated into three components at different resolutions, shortly {H, M, L}. E.g., H may refer to the first partial/input/output representations, M may refer to the second partial/input/output representations and L may refer to the third partial/input/output representations. Further, E n may represent the n-th layer of the encoding stage CNN 24.

The tuple

$$( \frac{{c}_{0}}{c} , \frac{{c}_{1}}{c} , \frac{{c}_{2}}{c} )$$

states the composition among the c total channels. For example, c₀ may represent the number of the first partial representations, c₁ may represent the number of second partial representations, and c₃ may represent the number of third partial representations. The outputs zₙ₊₁=Eₙ(zₙ) are computed as

$${E}_{n} ( {z}_{n} ) = ( \begin{matrix}\begin{matrix}{f}_{n , H \to H} ( {z}_{n , H} ) + {f}_{n , M \to H} ( {f}_{n , M \to M} ( {z}_{n , M} ) ) \\ {f}_{n , M \to M} ( {z}_{n , M} ) + \frac{1}{2} ( {f}_{n , H \to M} ( {f}_{n , H \to H} ( {z}_{n , H} ) )\end{matrix} \\ + {F}_{n , L \to M} ( {f}_{n , L \to L} ( {z}_{n , L} ) ) ) \\ {f}_{n , L \to L} ( {z}_{n , L} ) + {f}_{n , M \to L} ( {f}_{n , M \to M} ( {z}_{n , M} ) )\end{matrix} ) .$$

Here,
f_{n,H→H}, f_{n,M→M}, f_{n,L→L} are k×k convolutions with downsampling rates dₙ=const, and may optionally correspond to the first to third convolution modules 27¹⁻³ for the encoding stage CNN,
f_{n,H→M}, f_{n,M→L} are k×k convolutions with constant spatial downsampling rate 2, and may optionally correspond to the first and second cross component convolution modules 28¹⁻² for the encoding stage CNN,
f_{n,M→H}, f_{n,L→M} are k×k transposed convolutions with constant upsampling rate 2. And may optionally correspond to the second and third cross component transposed convolution modules 29²⁻³ for the encoding stage CNN,

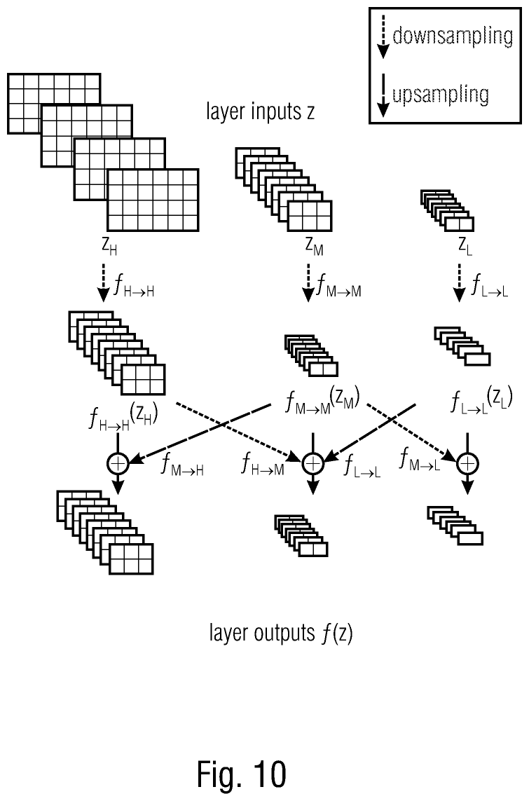

The cross-component convolutions ensure an information exchange between the three components at every stage; see FIG. 10, and FIG. 9. The input image is treated differently, with the initial layer value z₀:=x and

$${E}_{0} ( {z}_{0} ) = ( \begin{matrix}\begin{matrix}{z}_{1 , H} \\ {z}_{1 , M}\end{matrix} \\ {z}_{1 , L}\end{matrix} ) = ( \begin{matrix}\begin{matrix}{f}_{0 , H \to H} ( {z}_{0} ) \\ {f}_{0 , H \to M} ( {z}_{1 , H} )\end{matrix} \\ {f}_{0 , M \to L} ( {z}_{1 , M} )\end{matrix} ) .$$

Analogously, let z=E(x) be the features and z′_{N}:=\hat{z} its quantized version. The decoder network consists of multi-resolution upsampling convolutions with functions gₙ as

D=D₁∘. . . ∘D_{N}

Note that the order of the indices has been reversed here. In particular, the outputs z′ₙ₋₁=Dₙ(z′ₙ), n≠1 are computed with

$${D}_{n} ( {z}_{n}^{′} ) = ( \begin{matrix}\begin{matrix}{g}_{n , H \to H} ( {z}_{n , H}^{′} ) + {g}_{n , M \to H} ( {g}_{n , M \to M} ( {z}_{n , M}^{′} ) ) \\ {g}_{n , M \to M} ( {z}_{n , M}^{′} ) + \frac{1}{2} ( {g}_{n , H \to M} ( {g}_{n , H \to H} ( {z}_{n , H}^{′} ) )\end{matrix} \\ + {g}_{n , L \to M} ( {g}_{n , L \to L} ( {z}_{n , L}^{′} ) ) ) \\ {g}_{n , L \to L} ( {z}_{n , L}^{′} ) + {g}_{n , M \to L} ( {g}_{n , M \to M} ( {z}_{n , M}^{′} ) )\end{matrix} ) .$$

Here, a g_{n,H→H}, g_{n,M→M}, g_{n,L→L} are transposed k×k convolutions with upsampling rates uₙ=const. The sampling rates of the cross component convolutions are indicated by their indices. The maps a g_{n,H→M}, g_{n,M→L} are k×k convolutions with constant spatial downsampling rate 2 and the maps g_{n,M→H}, g_{n,L→M} are k×k transposed convolutions with constant upsampling rate 2. Finally, the reconstruction is defined as \hat{x}:=z′_{0,H}, where the last layer is computed as

$${D}_{1} ( {z}_{1}^{′} ) = ( \begin{matrix}\begin{matrix}{z}_{0 , H}^{′} \\ {z}_{0 , M}^{′}\end{matrix} \\ {z}_{0 , L}^{′}\end{matrix} ) = ( \begin{matrix}\begin{matrix}{g}_{1 , H \to H} ( {z}_{1 , H}^{′} ) + {g}_{1 , M \to H} ( {z}_{0 , M}^{′} ) \\ {g}_{1 , M \to M} ( {z}_{1 , M}^{′} ) + {g}_{1 , L \to M} ( {z}_{0 , L}^{′} )\end{matrix} \\ {g}_{1 , L \to L} ( {z}_{1 , L}^{′} )\end{matrix} ) .$$

Table 1 summarizes an example of the architecture of the maps in (2) and (3) on the basis of the multi-resolution convolution described in this section. It is noted, that the number of channels may be chosen different in further embodiments, and that the number of input and output channels of the individual layers, such as layers 2 and 3 of E, and layers 1 and 2 of D, is not necessarily identical, as described in section 4. Also, the Kernel size is to be understood exemplarily. Same holds for the Composition, which may alternatively chosen according to the criterions described in section 4.

TABLE 1

| Component | Composition | Kernel | In | Out | Act |
|---|---|---|---|---|---|
| Encoder E | $( \frac{3}{4} , \frac{3}{16} , \frac{1}{16} )$ | 5 × 5 ↓ | 1 | 256 | GDN |
| | $( \frac{3}{4} , \frac{3}{16} , \frac{1}{16} )$ | 5 × 5 ↓ | 256 | 256 | GDN |
| | $( \frac{3}{4} , \frac{3}{16} , \frac{1}{16} )$ | 5 × 5 ↓ | 256 | 256 | None |
| Decoder D | $( \frac{3}{4} , \frac{3}{16} , \frac{1}{16} )$ | 5 × 5 ↑ | 256 | 256 | IGDN |
| | $( \frac{3}{4} , \frac{3}{16} , \frac{1}{16} )$ | 5 × 5 ↑ | 256 | 256 | IGDN |
| | (1, 0, 0) | 5 × 5 ↑ | 256 | 1 | None |
| Hyper Encoder E′ | $( \frac{3}{4} , \frac{3}{16} , \frac{1}{16} )$ | 3 × 3 | 256 | 256 | ReLU |
| | $( \frac{3}{4} , \frac{3}{16} , \frac{1}{16} )$ | 5 × 5 ↓ | 256 | 256 | ReLU |
| | $( \frac{3}{4} , \frac{3}{16} , \frac{1}{16} )$ | 5 × 5 ↓ | 256 | 256 | None |
| Hyper Decoder D′ | $( \frac{3}{4} , \frac{3}{16} , \frac{1}{16} )$ | 5 × 5 ↑ | 256 | 256 | ReLU |
| | $( \frac{3}{4} , \frac{3}{16} , \frac{1}{16} )$ | 5 × 5 ↑ | 256 | 384 | ReLU |
| | $( \frac{3}{4} , \frac{3}{16} , \frac{1}{16} )$ | 3 × 3 | 384 | 512 | None |

The auto-encoder: Each row denotes a multi-resolution convolutional layer; see Section 2.2. “Kernel” shows the dimensions of the kernels and whether it performs a downsampling ↓ or upsampling ↑. “In” and “Out” denote the channels, e.g. the number of input representations and output representations of the respective layer. “Composition” states the composition of the output channels, e.g. the number of first output representations, second output representations and the third output representations of the respective layer. “Act” states the activations, which may specify an activation function, which may be applied to the side of each convolution or transposed convolution of the respective layer. The named activations maybe examples for the nonlinear normalizations as explained in section. For the example of a downsampling rate of d₁ = d₂ = d₃ = 2, the total number of features may be $( 3 + \frac{13}{64} ) H W .$ .

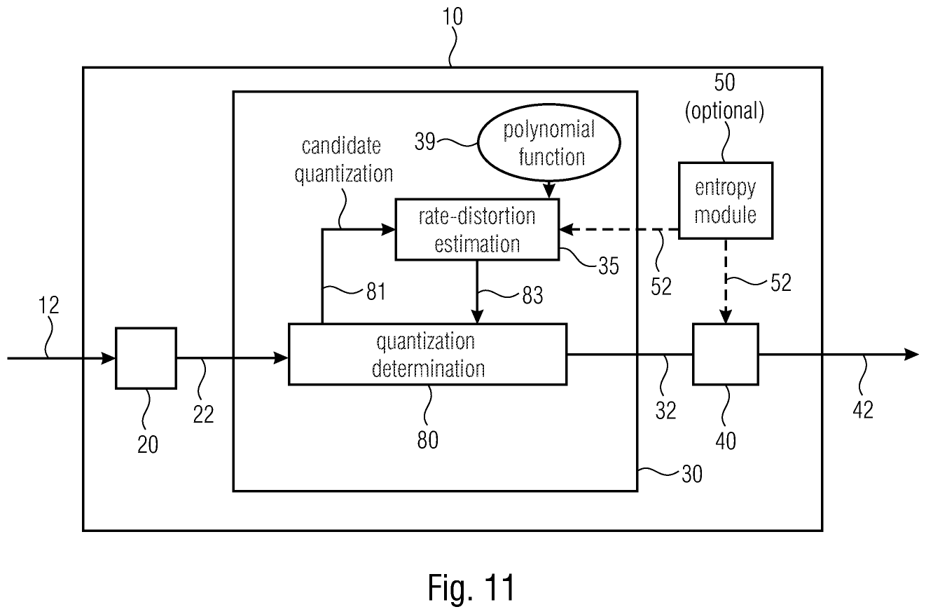

### 6. Encoder 10 According to FIGS. 11 to 13

In this section, embodiments of an encoder 10 are described. The encoder 10 according to FIG. 11 may optionally correspond to the encoder 10 according to FIG. 1. For example, the quantizer 30 of encoder 10 of FIG. 1 may optionally be implemented as described with respect to quantizer 30 in this section. The encoder 10 according to FIG. 11 may optionally be combined with the embodiments of the entropy module 50, 51 of FIG. 3 and FIG. 4. Also, the encoder 10 according to FIG. 11 may optionally be combined with any of the embodiments of the encoding stage 20 described in sections 4 and 5. However, encoder according to FIG. 11 may also be implemented independently from the details described in sections 1 to 5.

FIG. 11 illustrates an apparatus 10, or encoder 10, for encoding a picture 12 according to an embodiment. Encoder 10 according to FIG. 11 comprises an encoding stage 20 comprising a multi-layered convolutional neural network, CNN, for determining a feature representation 22 of the picture 12. Encoder 10 further comprises a quantizer 30 configured for determining a quantization 32 of the feature representation 22. For example, the quantizer may determine, for each of features of the feature representation a corresponding quantized feature of the quantization 32. Encoder 10 further comprises an entropy coder 40 which is configured for entropy coding the quantization using a probability model 52, so as to obtain a binary representation 42. For example, the probability model 52 may be provided by an entropy module 50 as described with respect to FIG. 1. The quantizer 30 is configured for determining the quantization 32 by testing a plurality of candidate quantizations of the feature representation 22. The quantizer 30 may comprise a quantization determination module 80, which may provide the candidate quantizations 81. The quantizer 30 comprises a rate-distortion estimation module 35. The rate-distortion estimation module 35 is configured for determining, for each of the candidate quantizations 81, an estimated rate-distortion measure 83. The rate-distortion estimation module 35 uses a polynomial function 39 for determining the estimated rate-distortion measure 83. The polynomial function 39 is a function between a quantization error and an estimated distortion resulting from the quantization error.

For example, the quantization error, for which the polynomial function 39 provides the estimated distortion, is a measure for a difference between quantized features of a candidate quantization, for which the estimated distortion is to be determined, and features of a feature representation to which the estimated distortion refers. According to embodiments, the polynomial function 39 provides an distortion approximation as a function of a displacement or modification of a single quantized feature. In other words, the estimated distortion may according to these embodiments represent a contribution to a total distortion of a quantization which contribution results from a modification of a single quantized feature of the quantization.

According to an embodiment, the polynomial function 39 is a sum of distortion contribution terms each of which is associated with one of the quantized features. Each of the distortion contribution terms may be a polynomial function between a quantization error of the associated quantized feature and a distortion contribution resulting from the quantization error of the associated quantized feature. Consequently, a difference between the estimated distortions of a first quantization and a second quantization, which estimated distortions are determined using the polynomial function, may be determined by considering the distortion contributions associated with the quantized features of the first quantization and the second quantizations which differ from each other. For example, the estimated distortion according to the polynomial function of a first quantization differing from a second quantization in one of the quantized features, i.e. a modified quantized feature, may be calculated on the basis of the distortion contribution terms of the modified quantized feature of the first and second quantizations.

According to embodiments, the polynomial function as a nonzero quadratic term and/or a nonzero by biquadratic term. Additionally or alternatively, a constant term and a linear term of the polynomial function are zero. Additionally or alternatively, uneven terms of the polynomial function of zero.

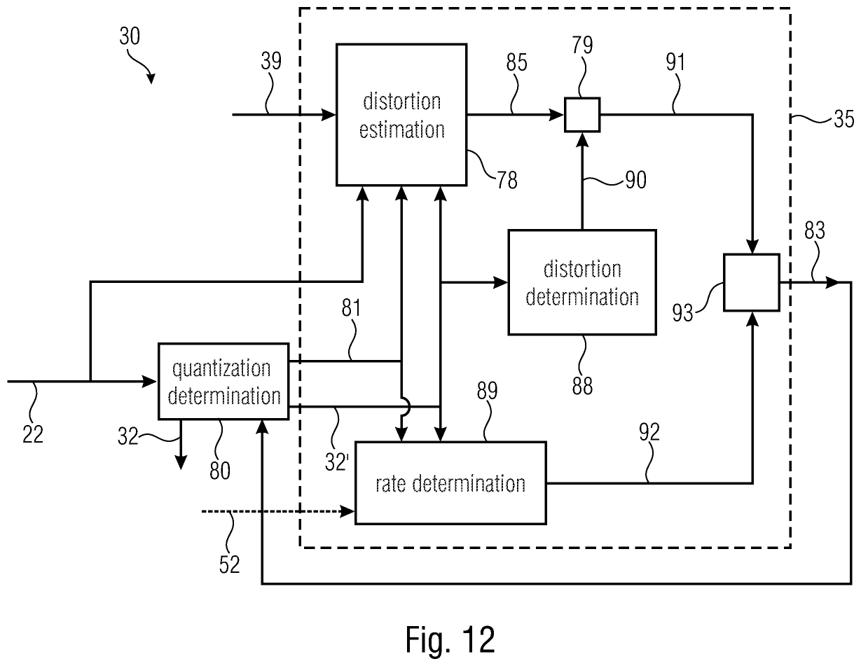

FIG. 12 illustrates an embodiment of the quantizer 30. According to the embodiment of FIG. 12, the quantization determination module 80 determines a predetermined quantization 32′ of the feature representation 22. The quantizer 30 according to FIG. 12 is configured for determining a distortion 90 which is associated with the predetermined quantization 32′, for example by means of a distortion determination module 88 which may be part of the rate-distortion estimation module 35. The quantization determination module 80 further provides a candidate quantization to be tested, that is, a currently tested one of the candidate quantizations, which may be referred to as tested candidate quantization 81. The tested candidate quantization 81 differs from the predetermined quantization 32′ in a modified quantized feature. In other words, at least one of the quantized features of the tested candidate quantization 81 differs from its corresponding quantized feature of the predetermined quantization 32′.

According to some embodiments, the quantization determination module 80 may determine a first predetermined quantization as the predetermined quantization 32′ by rounding the features of the feature representation 22 using a predetermined rounding scheme. According to alternative embodiments, the quantization determination module 80 may determine the first predetermined quantization by determining a low-distortion feature representation on the basis of the feature representation. To this end, the quantization determination module 80 may minimize a reconstruction error associated with the low-distortion feature representation to be determined, i.e. the unquantized low-distortion feature representation to be determined. That is, the quantization determination module 80 may, starting from the feature representation 22, adapt the feature representation so as to minimize the reconstruction error of the unquantized low-distortion feature representation. Minimizing may refer to adapting the feature representation so that the reconstruction error reaches a local minimum within a given accuracy. E.g., a gradient decent method may be used, or any recursive method for minimizing multi-dimensional data. The quantization determination module 80 may quantize the determined the predetermined quantization by quantizing the low-distortion feature representation, e.g. by rounding.

For determining the reconstruction error during minimization, the quantization determination module 80 may use a further CNN, e.g. CNN 23 such as implemented in decoding stage 21 for reconstructing the picture from the feature representation. That is, the quantization determination module 80 may use the further CNN for determining the reconstruction error for a currently tested unquantized low-distortion feature representation.

The rate-distortion estimation module 35 comprises a distortion estimation module 78. The distortion estimation module 78 is configured for determining a distortion contribution associated with the modified quantized feature of the tested candidate quantization 81. The distortion contribution represents a contribution of the modified quantized feature to an approximate distortion 91 associated with the tested candidate quantization 81. The distortion estimation module 78 determines the distortion contributions using the polynomial function 39. The rate-distortion estimation module 35 is configured for determining the rate-distortion measure 83 associated with the tested candidate quantization 81 on the basis of the distortion 90 of the predetermined quantization 32′ and on the basis of the distortion contribution associated with the tested candidate quantization 81.

According to embodiments, the rate-distortion estimation module 35 may comprise a distortion approximation module 79 which determines the approximated distortion 91 associated with the tested candidate quantization 81 on the basis of the distortion associated with the predetermined quantization 32′ and on the basis of a distortion modification information 85, which is associated with the modified quantized feature of the tested candidate quantization 81. The distortion modification information 85 may indicate an estimation for a change of the distortion of the tested candidate quantization 81 with respect to the distortion associated with the predetermined quantization 32′ reciting from the modification of the modified quantized feature.

The distortion modification information 85 may for example be provided as a difference between the distortion contribution to an estimated distortion of the tested candidate quantization 81 determined using the polynomial function 39, and a distortion contribution to an estimated distortion of the predetermined quantization 32′ determined using the polynomial function 39, the distortion contributions being associated with the modified quantized feature. In other words, the distortion approximation module 79 is configured for determining the distortion approximation 91 on the basis of the distortion 90 associated with the predetermined quantization, the distortion contribution associated with the modified quantized feature of the tested candidate quantization 81, and a distortion contribution associated with a quantized feature of the predetermined quantization 32′, which quantized feature is associated with the modified quantized feature, for example associated by its position within the respective quantizations. In other words, the distortion modification information 85 may correspond to a difference between a distortion contribution associated with a quantization error of a feature value of the modified quantized feature in the tested candidate quantization 81 and a distortion contribution of a quantization error associated with a feature value of a modified quantized feature in the predetermined quantization 32′. Thus, the distortion estimation module 78 may use the feature representation 22 to obtain quantization errors associated with feature values of the quantized features of the predetermined quantization 32′ and/or the tested candidate quantization 81.

According to embodiments, the rate-distortion estimation module 35 comprises a rate-distortion evaluator 93, which determines the rate-distortion measure 83 on the basis of the approximated distortion 91 and a rate 92 associated with the tested candidate quantization 81.

The rate-distortion estimation module 35 comprises a distortion determination module 88. The distortion determination module 88 determines the distortion 90 associated with the predetermined quantization 32′ by determining a reconstructed picture based on the predetermined quantization 32′ using a further CNN, for example the decoding stage CNN 23. For example, the further CNN is trained together with the CNN of the encoding stage to reconstruct the picture 12 from a quantized representation of the picture 12, the quantized representation being based on the feature representation which has been determined using the encoding stage 20. Distortion determination module 88 may determine the distortion of the predetermined quantization 32′ is a measure of the difference between the picture 12 and the reconstructed picture.

According to embodiments, the rate-distortion estimation module 35 further comprises a rate determination module 89. The rate determination module 89 is configured for determining the rate 92 associated with the tested candidate quantization 81. The rate determination module 89 may determine a rate associated with the predetermined quantization 32′, and may further determine a rate contribution associated with the modified quantized feature of the tested candidate quantization 81. The rate contribution may represent a contribution of the modified quantized feature to the rate 92 associated with the tested candidate quantization 81. For example, the rate determination method 89 may determine the rate associated with the tested candidate quantization 81 on the basis of the rate determined for the predetermined quantization 32′ and on the basis of the rate contribution associated with the modified quantized feature of the test candidate quantization, and a rate contribution associated with the quantized feature of the predetermined quantization 32′, which quantized feature is associated with the modified quantized feature.

For example, the rate determination module 89 may determine the rate associated with the predetermined quantization on the basis of respective rate contributions of quantized features of the predetermined quantization 32′.

According to embodiments, the rate determination module 89 determines a rate contribution associated with a quantized feature of a quantization on the basis of a probability model 52 for the quantized feature. The probability model 52 for the quantized feature may be based on a plurality of previous quantized features according to a coding order for the quantization. For example, the probability model 52 may be provided by an entropy module 50, which may determine the probability model 52 for the currently considered quantized feature based on previous quantized features, and optionally further based on information about a spatial correlation of the feature representation 22, for example the second probability parameter 84 as described with respect to sections 1 to 3.

According to embodiments, the quantization determination module 80 compares the estimated rate-distortion measure 83 determined for the tested candidate quantization 81 to a rate-distortion measure 83 of the predetermined quantization 32′. If the estimated rate-distortion measure 83 of the tested candidate quantization 81 indicates a lower rate at equal distortion, and/or a lower distortion at equal rate, the quantizations determination module may consider to define the tested candidate quantization as the predetermined quantization 32′, and may keep the predetermined quantization 32′ otherwise. In examples, the quantization determination module 80 may, after having tested each of the plurality of candidate quantizations, the predetermined quantization 32′ as the quantization 32.

The quantization determination module 80 may use a predetermined set of candidate quantizations. Alternative, the quantization determination module 80 may determine the tested candidate quantization 81 in dependence on a previously tested candidate quantization.

According to embodiments, the quantization determination module 80 may determine the candidate quantizations by rounding each of the features of the feature representation 22 so as to obtain a corresponding quantized feature of the candidate quantization. According to these embodiments, the quantization determination module may determine the tested candidate quantizations by selecting, for one of the quantized features of the test candidate quantization, a quantization feature candidate out of a set of quantized feature candidates. For example, the quantization determination module 80 may modify one of the quantized features with respect to the predetermined quantization 32′, by selecting the value for the quantized feature to be modified out of the set of quantized feature candidates.

The quantization determination module 80 may determine the set of quantized feature candidates for a quantized feature by one or more out of rounding up the feature of the feature representation which is associated with a quantized feature, rounding down the feature of the feature representation which is associated with the quantized feature, and using an expectation value of the feature, the expectation value being determined on the basis of the entropy model 52, or being provided by the entropy model 52.

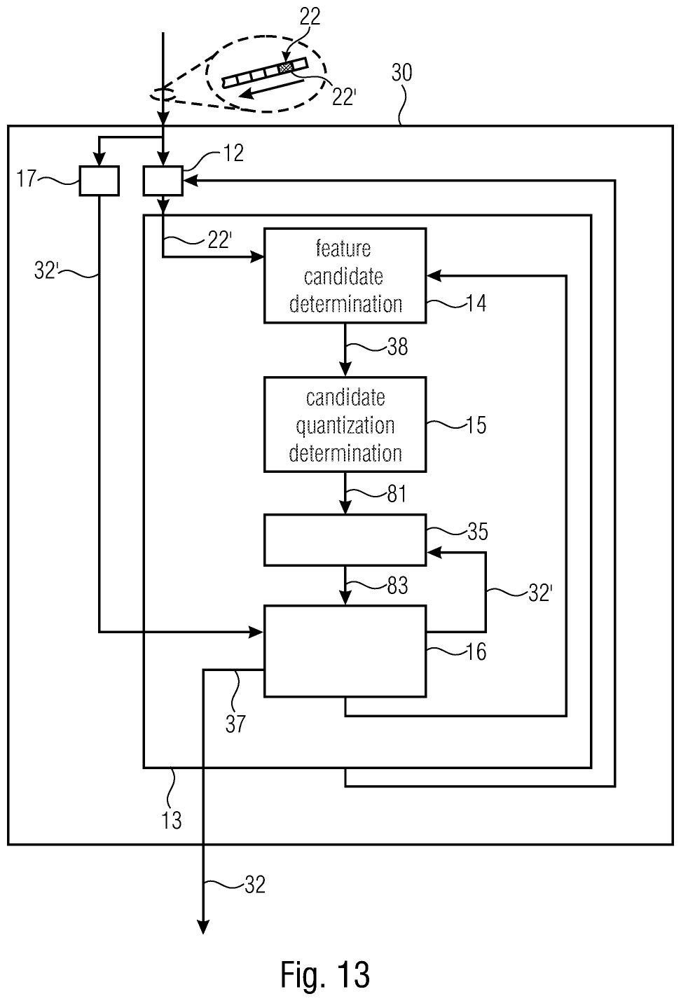

FIG. 13 illustrates an embodiment of the quantizer 30 which may optionally be implemented in encoder 10 according to FIG. 11 and optionally in accordance with FIG. 12. According to FIG. 13, the quantizer 30 is configured for determining, for each of features 22′ of the feature representation 22 a quantized feature of the quantization 32. Further, the entropy coder 40 of encoder 10 is in accordance with the quantizer 30 of FIG. 13 configured for entropy coding the quantized features of the quantization 32 according to the coding order. Thus, in examples, the quantizer 30 may determine the quantized features of the quantization 32 according to the coding order.

Accordingly, the quantizer 30 may be configured for determining the quantization 32 by testing for each of the features 22′ of the feature representation 22 each out of the set of quantized feature candidates for quantizing the feature, wherein the quantizer 30 may perform the testing for the features according to the coding order. In other words, after having determined in the quantized feature for one of the features this quantized feature maybe entropy coded, and thus may be fixed for subsequently tested candidate quantizations 32′.

According to embodiments, the quantizer 30 comprises an initial predetermined quantization determination module 17 which determines an initial predetermined quantization 32′ which may be used as the predetermined quantization 32′ for testing a first quantized feature candidate for the first feature of the feature representation 22. For example, the initial predetermined quantization determination module 17 may determine the initial predetermined quantization 32′ by rounding each of features of the feature representation 22, i.e. using the same rounding scheme for each of the features, or by determining the quantization of the low-distortion feature representation as described with respect to FIG. 12.

The quantizer 30 according to FIG. 13 may have a feature iterator 12 for selecting a feature 22′ of the feature representation 22 for which the quantized feature is to be determined. Quantizer 30 may comprise a quantized feature determination stage 13 for determining a quantized feature 37 of the feature 22′. The quantized feature determination stage 13 may comprise a feature candidate determination stage 14 which determines a set of quantized feature candidates for the feature 22′. For example, the set of quantized feature candidates for the feature 22′ may comprise, as described above, a rounded up value of the feature 22′ a rounded down and value of the feature 22′ and optionally also an expectation value of the feature 22′. For each quantized feature candidate 38 out of the set of quantized feature candidates, the quantized feature determination stage 13 determines a corresponding candidate quantization, e.g. by means of candidate quantization determination module 15. Candidate quantization determination module 50 may determine a currently test candidate quantization, i.e. the tested candidate quantization 81, so that the tested candidate quantization 81 differs from the predetermined quantization 32′ in that the quantized feature associated with the feature 22′ is replaced by the quantized feature candidate 37. For example, the candidate quantization determination stage 15 may replace, in the predetermined quantization 32′, the quantized feature which is associated with the feature 22′ by the quantized feature candidate 37. The quantized feature determination stage 13 determines the estimated rate-distortion measure 83 associated with the test candidate quantization 81 using the rate-distortion estimation module 35, for example as described with respect to FIG. 12. The quantized feature determination stage 13 comprises a predetermined quantization determination module 16 which may consider a redefining of the predetermined quantization 32′ in dependence on the estimated rate-distortion measure.

According to embodiments, the predetermined quantization determination module 16 may compare the estimated rate-distortion measure 83 determined for the tested quantization feature candidate 37 to a rate-distortion measure associated with the predetermined quantization 32′. The rate-distortion measure for the predetermined quantization 32′ may be determined on the basis of the distortion 90 associated with the predetermined quantization 32′ and on the basis of the rate of the predetermined quantization 32′ as it may be determined by the rates determination module 89. If the estimated rate-distortion measure 83 determined for the tested quantization feature candidate 37 indicates that the tested quantization candidate 81 is associated with a higher rate at equal distortion, and/or a higher distortion at equal rate, the predetermined quantization determination module may consider a redefining of the predetermined quantization, and else may keep the predetermined quantization 32′ as the predetermined quantization 32′.

According to embodiments, the quantized feature determination stage 13 may, in case that the estimated rate-distortion measure 83 determined for the tested quantized feature candidate 37 indicates that the tested quantization candidate 81 is associated with a higher rated equal distortion and/or a higher distortion at equal rate, determine a rate-distortion measure associated with the tested candidate quantization 81. The rate-distortion measure may be determined by determining a reconstructed picture based on the tested candidate quantization 81 using the further CNN, as described with respect to the determination of the distortion of the predetermined quantization 32′. The quantizer 30 may be configured for determining the distortion as a measure of the difference between the picture in the reconstructed picture, e.g. by means of distortion determination module 88, and to determine the rate-distortion measure associated with the tested candidate quantization 81 on the basis of the distortion determined on the basis of the reconstructed picture. The such determined rate-distortion measure associated with the tested candidate quantization 81 may be more accurate than the estimated rate-distortion measure, as using the reconstructed picture may allow for an accurate determination of the distortion. The quantized feature determination stage 13 may compare the rate-distortion measure associated with the tested quantized feature candidate to the rate-distortion measure associated with the predetermined quantization. If the rate-distortion measure determined for the test candidate quantization 81 indicates that the tested candidate quantization 81 is associated with a higher rated equal distortion, or a higher distortion at equal rate, the predetermined quantization determination module 16 may use the tested candidate quantization 81 as the predetermined quantization 32′, and else may keep the predetermined quantization 32′ as the predetermined quantization 32′. Thus, in case that the tested candidate quantization 81 is used as the predetermined quantization 32′, the distortion 90 of the predetermined quantization 32′ may already be available.

### 7. Quantization Determination for Auto-Encoders

This section describes an embodiment of a quantizer as it may optionally be implemented in the encoder architecture described in section 2, optionally and beneficially in combination with the implementation of the auto-encoder E and the auto-decoder D described in section 5. The herein described quantization may be a specific embodiment of the quantizer 30 as implemented in the encoder 10 and the decoder 20 of FIG. 1 and FIG. 2, optionally yet advantageously in combination with the implementations of the entropy module 50, 51 of FIG. 3 and FIG. 4. In particular, the encoding scheme described in this section may optionally be an examples of the encoder of FIG. 11, in particular as implemented according to FIG. 12 and FIG. 13. Thus, details described within this section may be examples for implementing the quantizer 30 as described with respect to FIG. 12 and FIG. 13. However, it should be noted, that the herein described encoding scheme may be implemented independently from the details described in section 6. The notation used as in this section is accordance with section 2, which holds in particular for the relation between the notation of section 2 and features of FIGS. 1 to 4.

Compression systems like those used in [11] [16] to are based on a symmetry between encoder and decoder, and they are implemented without signal-dependent encoder optimizations. However, designing such optimizations requires to understand the impact of the quantization. For linear, orthogonal transforms, the rate-distortion performance of different quantizers is well-known; [17]. On the other hand, it is rather difficult to estimate the impact of feature changes on the distortion for non-linear transforms. The purpose of this paper is to describe an RDO algorithm for refining the quantized features and improving the rate-distortion trade-off.

Suppose that the side information ŷ and the hyper parameters θ are fixed. We may consider

$$w ∈ {ℤ}^{W \times h \times {c}_{0}} ⊕ {ℤ}^{\frac{w}{2} \times \frac{h}{2} \times {c}_{1}} ⊕ {ℤ}^{\frac{w}{4} \times \frac{h}{4} \times {c}_{2}}$$

as a set of possible coding options. Provided, we are able to efficiently compute the distortion and the expected bitrate, the rate-distortion loss can be expressed as

d(w)=∥x−D(w)∥²,R(w,θ)=ΣₗRₗ(wₗ;θ), (10)

J(w)=d(w)+λ(R′+R(w,θ)), (11)

E.g., distortion determination module 88 of FIG. 12 may apply (12) for determining the distortion of the predetermined quantization 32′. As described with respect to FIG. 13, this step may be performed in the context of determining the distortion for the tested candidate quantization 81. Rate-distortion estimator 93 of FIG. 12 may, for example, apply (11).

In (11), R′ is the constant bitrate of the side information. It is important to note that \hat{z}≠argmin J(w) holds in general. In other words, the encoder typically does not minimize J, although \hat{z} certainly provides an efficient compression of the input image. Note that changing an entry wₗ affects multiple bitrates due to (5). Furthermore, we simply assume uniform scalar quantization and disregard other quantization methods for optimizing the loss term (11). In existing video codecs, the impact of different coding options on d and R is well-understood. This has enabled the design of tailor-made algorithms for finding optimal coding decisions. For end-to-end compression systems, understanding the impact of different coding decisions on (11) is rather difficult, due to the non-linearity of (2). However, it turns out that optimization is possible by exhaustively testing different candidates w. Therefore, our goal is to implement an efficient algorithm for optimizing the quantized features. Similar to the fast-search methods in video codecs, our algorithm should avoid the evaluation of less promising candidates. This can be accomplished by estimating the distortion d(w) without executing the decoder network. Furthermore, it may be only necessary to re-compute the bitrate Rₗ (and possibly Rₗ₊₁, . . . , R_{l+L}) when a single entry w 1 is changed.

7.1 Distortion Estimation by a Biquadratic Polynomial

The biquadratic port polynomial described within this section may optionally be applied as the polynomial function 39 introduced with respect to FIG. 11.

A basic property of orthogonal transforms is perfect reconstruction, which auto-encoders do not satisfy in general. However, we can expect for inputs x˜pₓ and features z=E(x) that D(z) is an estimate at least as good as D(\hat{z}), i. e.

0≤∥x−D(z)∥²≤∥x−D(\hat{z})∥².

In particular, it is desirable to ensure that z is close to a local minimum of the distortion d. This can be accomplished by adding the minimization of ∥x−D(E(x))∥² as a secondary condition to the training of the network or by training for smaller values of A. Next, we define the following auxiliary function for displacements h as

ε(h):=∥D(z)−D(z+h)∥².

Note that ε(0)=0 is a minimum and thus, the gradient is

∇_{ε}(0)=0.

Thus, by Taylor's theorem, the impact of displacements h on E can be approximated by a higher-order polynomial without constant and linear term. Given the feature channels z=(z⁽¹⁾, . . . , z^{(c)}), we evaluated ε(h) for different single-channel displacements

h∈{(h⁽¹⁾,0, . . . ,0),(0,h⁽²⁾, . . . ,0), . . . ,(0,0, . . . ,h^{(c)})}

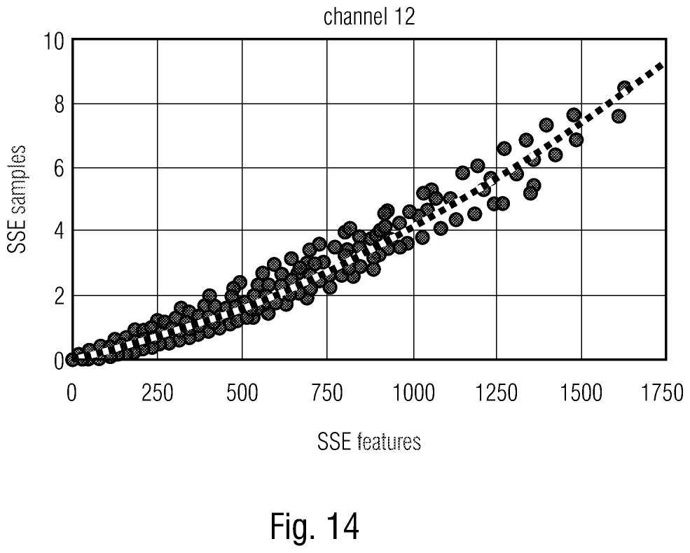

on a set of sample images; see FIG. 14. Given our data, we found that ε(h) is approximated well enough by a polynomial which only depends on the squared norms of the inputs.

FIG. 14 shows a an example of the relationship of single-channel feature displacements and the distortion for λ=128. The blue dots are evaluations (∥h⁽¹²⁾∥², ε(h)) for multiple images, the orange line is the fitted polynomial (12).

Consequently, we fitted the following biquadratic polynomial to the data by a least-squares approximation

ε(h)≈Σⱼ₌₁^{c}(γ₁^{(j)}∥h^{(j)}∥²+γ₂^{(j)}∥h^{(j)}∥⁴). (12)

For example, the distortion estimation module 78 may apply (12) or part of it such as one or more of the summand terms of (12), for determining the distortion contribution of the modified quantized feature of the tested candidate quantization 81, and optionally also the distortion contribution of the quantized feature of the predetermined quantization 32′, which quantized feature is associated with the modified quantized feature. E.g., ε(h) may be referred to as estimated distortion associated with a quantized representation which is represented by h.

The inventors realized, that by using the triangle inequality, one can estimate the distortion of w=z+h as

d(w)≤d(z)+Σⱼ₌₁^{c}(γ₁^{(j)}∥h^{(j)}∥²+γ₂^{(j)}∥h^{(j)}∥⁴), (13)

Thus, the upper bound may be as an estimate of d(w). E.g. the distortion approximation 91 may be based on this estimation. Further note that for orthogonal transforms, the inequality holds with γ₁^{(j)}=1 and γ₂^{(j)}=0. In the case, when z is not a local minimum of d, it may be beneficial to re-compute a different z which decreases the unquantized error ∥x−D(z)∥², for instance by using a gradient descent method. When z is close to a local minimum of d, we have the lower bound d(z)≤d(w) in addition to (13) which further improves the accuracy of the distortion approximation. The higher the accuracy of the distortion approximation, the more executions of the decoder may be avoided during determination of the quantization. The following algorithm, which optimizes the rate-distortion trade-off (11), avoids numerous executions of the decoder by estimating the distortion by the approximation (13).

The following algorithm 1 may represent an embodiment of the quantizer 30, and may optionally be an embodiment of the quantizer 30 as described with respect to FIG. 13. For example, wⁱ may correspond to the candidate quantization 82, I may indicate an index or a position of the modified quantized feature in the candidate quantization. In the example of Algorithm 1, the quantized feature candidate is determined by modifying the corresponding feature of the feature representation, and quantizing the modified feature wₗ, thus the set of quantized feature candidates may be represented by cand. dⁱ may correspond to the distortion approximation 91, d* may correspond to the distortion of the predetermined quantization 32′, Jⁱ may correspond to the estimated rate-distortion measure 83. Rⁱ may correspond to the rate associated with the candidate quantization 81. Rₗⁱ may correspond to the rate contribution associated with the modified quantized feature of the tested candidate quantization, R*ₗ may correspond to the rate contribution associated with the corresponding quantized feature of the predetermined quantization 32′.

Algorithm 1: Fast rate-distortion optimization for the auto-encoder with user-defined step size δ.

```
Result: w*
Given: x, z, θ, R′, {(γ₁^{(j)}, γ₂^{(j)})}, δ;
(z, θ) |→ μ via (5);
Set w: = z, w*: = ŵ, h*: = w − w*;
R* = R(w*, θ), d* = d(w*), J* = J(w*) via (10);
for each feature position l do
  Set cand = {wₗ − δₗ, wₗ + δₗ, μₗ};
  R*ₗ: = Rₗ(w*ₗ) via (10);
  ε* = ε(h*) via (12);
  for i = 0, 1, 2 do
    Set wₗ: = cand[i], wⁱ: = ŵ, hⁱ: = w − wⁱ;
    Rₗⁱ = Rₗ(wₗⁱ, θ); Rⁱ: = R* − R*ₗ + Rₗⁱ via (10);
    εⁱ = ε(hⁱ); dⁱ: = d* − ε* + εⁱ via (12);
    if dⁱ + λ(Rⁱ + R′) < J* then
      dⁱ = d(wⁱ) via (10);
      if dⁱ + λ(Rⁱ + R′) = Jⁱ < J* then
        Set w*: = wⁱ, d*: = dⁱ, R*: = Rⁱ, J*: = Jⁱ, h*: = hⁱ, ε*: =
        εⁱ, R*ₗ: = Rₗⁱ
      end
    end
  end
end
```

The choice of δ is subject to the employed quantization scheme. According to embodiments, δₗ=1 for each position. Remark that the candidate value μₗ can be considered as a prediction constructed from the initial features z. The expected bitrate Rₗ(μₗ, θ) is minimal due to (7). Note that each change of a feature technically requires updates of the hyper parameters and the entropy model. The stated algorithm disregards these dependencies of the coding decisions, similar to the situation in hybrid, block-based video codecs. Finally, note that an exhaustive search for each candidate requires a total of N≈10HW decoder evaluations. Empirically, we have observed that Algorithm 1 reduces this number by a factor of approximately 25 to 50.

### 8. Advantages of the Invention

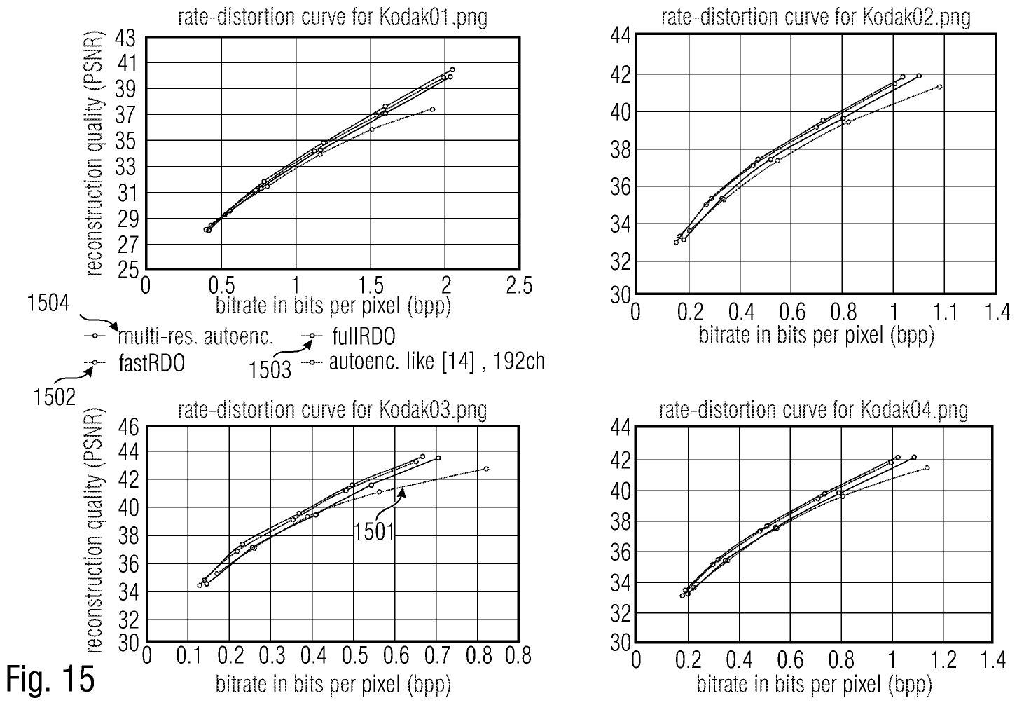

FIG. 15 illustrates an evaluation of several embodiments of the trained auto-encoders described in sections 2, 3, 5 and 7 on the Kodak set with luma-only versions of the images. As benchmark, an auto-regressive auto-encoder with the same architecture as with 192 channels is used, reference sign 1501. Benchmarks for an auto-encoder according to section 2 in combination with the multi-resolution convolution according to section 5 are indicated reference sign 1504, demonstrating the efficiency of the multi-resolution convolutions using three components. A combination of the auto-encoder according to section 2 and section 5, i.e. using the multi-resolution convolution, in combination with Algorithm 1 according to section 7 (“fast RDO”) and estimated the bitrate by the differential entropy, reference sign 1502. A version of the algorithm which re-computes the distortion for each candidate (“full RDO”) is shown using reference sign 1503. FIG. 15 demonstrates the effectiveness of optimizing the initial features in both versions. Similarly, the performance limits of the RDO in HEVC have been investigated in [21]. Furthermore, we report rate-distortion curves on the entire Kodak set over a PSNR range of 25.9-43.4 dB, comparing the output w* of Algorithm 1 to the initial value 2 as supplemental material. Remark that the compression performance of the trained auto-encoders greatly benefits from the encoder optimization. In other words, FIG. 15 demonstrates, that the fast RDO is close to the performance of the full RDO, which shows the benefit of using estimate (13). Note that the blue, orange and red curves have been generated using one and the same decoder.

The present disclosure thus provides an auto-encoder for image compression using multi-scale representations of the features, thus improving the rate-distortion trade-off. The disclosure further provides a simple algorithm for improving the rate-distortion trade-off, which increases the efficiency of the trained compression system.

The usage of algorithm 1 of section 7 avoids multiple decoder executions by pre-estimating the impact of feature changes on the distortion by a higher-order polynomial. Same applies to the embodiments of FIG. 11 to FIG. 13, in which the distortion estimation using the distortion estimation module 78 avoids several executions of the distortion determination module 88, cf. FIG. 12.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

Some or all of the method steps may be executed by (or using) a hardware apparatus, like for example, a microprocessor, a programmable computer or an electronic circuit. In some embodiments, one or more of the most important method steps may be executed by such an apparatus.

The inventive binary representation can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

The above described embodiments are merely illustrative for the principles of the present disclosure. It is understood that modifications and variations of the arrangements and the details described herein will be apparent to others skilled in the art. It is the intent, therefore, to be limited only by the scope of the pending patent claims and not by the specific details presented by way of description and explanation of the embodiments herein.

### REFERENCES

[1] W. Han G. J. Sullivan, J.-R. Ohm and T. Wiegand, “Overview of the high efficiency video coding (HEVC) standard,” IEEE Transactions on Circuits and Systems for Video Technology, vol. 22, no. 12, pp. 1649-1668, 2012.
[2] “High Efficiency Video Coding,” ITU-T Rec. H.265 and ISO/IEC 23008-10, 2013.
[3] M. Wien and B. Bross, “Versatile video coding—algorithms and specification,” in 2020 IEEE International Conference on Visual Communications and Image Processing (VCIP), 2020, pp. 1-3.
[4] “Versatile Video Coding,” ITU-T Rec. H.266 and ISO/IEC 23090-3, 2020.
[5] Matthias Wien, High Efficiency Video Coding-Coding Tools and Specification, Springer Verlag Berlin Heidelberg, 1 edition, pp. 1-314, 2015.
[6] G. J. Sullivan and T. Wiegand, “Rate-distortion optimization for video compression,” IEEE Signal Processing Magazine, vol. 15, no. 6, pp. 74-90, 1998.
[7] K. Ramchandran, A. Ortega, and M. Vetterli, “Bit allocation for dependent quantization with applications to multiresolution and mpeg video coders,” IEEE Transactions on Image Processing, vol. 3, no. 5, pp. 533-545, 1994.
[8] K. Ramchandran and M. Vetterli, “Rate-distortion optimal fast thresholding with complete jpeg/mpeg decoder compatibility,” IEEE Transactions on Image Processing, vol. 3, no. 5, pp. 700-704, 1994.
[9] M. Karczewicz, Y. Ye, and I. Chong, “Rate-distortion optimized quantization,” ITU-T SG16/Q6 (VCEG), January 2008. Johannes Ballé, Philip A. Chou, David Minnen, Saurabh Singh, Nick Johnston, Eirikur Agustsson, Sung Jin Hwang, and George Toderici, “Nonlinear transform coding,” 2020.
[11] Fabian Mentzer, Eirikur Agustsson, Michael Tschannen, Radu Timofte, and Luc Van Gool, “Conditional probability models for deep image compression,” 2018.
[12] Johannes Ballé, Valero Laparra, and Eero P. Simoncelli, “End-to-end optimized image compression,” CoRR, vol. abs ¹611.01704, 2016.
[13] Johannes Ballé, David Minnen, Saurabh Singh, Sung Jin Hwang, and Nick Johnston, “Variational image compression with a scale hyperprior,” 2018.
[14] David Minnen, Johannes Ballé, and George D Toderici, “Joint Autoregressive and Hierarchical Priors for Learned Image Compression,” in Advances in Neural Information Processing Systems, S. Bengio, H. Wallach, H. Larochelle, K. Grauman, N. Cesa-Bianchi, and R. Garnett, Eds. 2018, vol. 31, pp. 10771-10780, Curran Associates, Inc.
[15] Mohammad Akbari, Jie Liang, Jingning Han, and Chengjie Tu, “Generalized octave convolutions for learned multi-frequency image compression,” 2020.
[16] Stephane Mallat, A Wavelet Tour of Signal Processing, Third Edition: The Sparse Way, Academic Press, Inc., USA, 3^{rd} edition, 2008.
[17] V. K. Goyal, “Theoretical foundations of transform coding,” IEEE Signal Processing Magazine, vol. 18, no. 5, pp. 9-21, 2001.
[18] J. Deng, W. Dong, R. Socher, L.-J. Li, K. Li, and L. Fei-Fei, “ImageNet: A Large-Scale Hierarchical Image Database,” in CVPR09, 2009.
[19] Diederik P. Kingma and Jimmy Ba, “Adam: A method for stochastic optimization,” 2017.
[20] “Kodak image dataset,” last checked on 2021/01²0, available at http://r0k.us/graphics/kodak/.
[21] J. Stankowski, C. Korzeniewski, M. Doma′nski, and T. Grajek, “Rate-distortion optimized quantization in hevc: Performance limitations,” 2015 Picture Coding Symposium (PCS), pp. 85-89, 2015.

1. Apparatus for decoding a picture from a binary representation of the picture, wherein the decoder is configured for
deriving a feature representation of the picture from the binary representation using entropy decoding,
wherein the feature representation comprises a plurality of partial representations comprising first partial representations, second partial representations and third partial representations, wherein a resolution of the first partial representations is higher than a resolution of the second partial representations, and the resolution of the second partial representations is higher than a resolution of the third partial representations, and
using a multi-layered convolutional neural network, CNN, for reconstructing the picture from the feature representation.

2. Apparatus according to the claim 1, wherein a number of the first partial representations is at least one half or at least five eighths or at least three quarters of a total number of the first to third partial representations.

3. Apparatus according to claim 1, wherein a number of the second partial representations is at least one half or at least five eighths or at least three quarters of a total number of the second and third partial representations.

4. Apparatus according to claim 1, wherein a number of the first partial representations is in a range from one half to 15/16 or in a range between five eighths to seven eighths or in a range between three quarters and seven eighths of a total number of the first to third partial representations.

5. Apparatus according to claim 1, wherein a number of the second partial representations is in a range from one half to 15/16 or in a range between five eighths to seven eighths or in a range between three quarters and seven eighths of a total number of the second and third partial representations.

6. Apparatus according to claim 1, wherein the resolution of the first partial representations is twice or fourth the resolution of the second partial representations, and
wherein the resolution of the second partial representations is twice or fourth the resolution of the third partial representations.

7. Apparatus according to claim 1, wherein a first layer of the CNN is configured for receiving the partial representations as input representations, and for determining a plurality of output representations on the basis of the input representations,
wherein the output representations of the first layer comprise first output representations, second output representations and third output representations, wherein a resolution of the first output-representations is higher than a resolution of the second output representations, and the resolution of the second output representations is higher than a resolution of the third output representations, and
wherein the first layer is configured for
determining the first output representations on the basis of the first input representations and the second input representations,
determining the second output representations on the basis of the first input representations, the second input representations and the third input representations,
determining the third output representations on the basis of the second input representations and the third input representations.

8. Apparatus according to claim 7, wherein the apparatus is configured for applying non-linear normalizations to transposed convolutions of the first, second, and third input layers so as to determine the first, second, and third output representations.

9. Apparatus according to claim 7, wherein the first layer is a first one of a sequence of one or more layers, each of which is configured for receiving first, second and third input representations comprising mutual different resolutions and configured for upsampling same to acquire first, second and third output representations comprising mutual different resolutions, wherein a resolution of the first input representations is higher than a resolution of the second input representations, and the resolution of the second input representations is higher than a resolution of the third input representations, and wherein a resolution of the first output representations is higher than a resolution of the second output representations, and the resolution of the second output representations is higher than a resolution of the third output-representations,
a final layer configured for receiving, from a last one of the sequence of one or more layers, the first, second and third output representations, subject same to an upsampling to a target resolution of the picture, and combining same,
wherein each of the sequence of one or more layers is configured for determining the first output representations on the basis of the first input representations and the second input representations and the second output representations on the basis of the first, second and third input representations and the third output representations on the basis of the third input representations and the second input representations.

10. Apparatus according to claim 7, wherein the first layer is configured for
applying transposed convolutions to the first input representations to determine first upsampled representations comprising a higher resolution than the first input representations,
applying transposed convolution to the second input representations to determine second upsampled representations comprising a higher resolution than the second input representations and comprising a lower resolution than the first upsampled representations,
applying transposed convolutions to the third input representations to determine third upsampled representations comprising a higher resolution than the third input representations and comprising a lower resolution than the second upsampled representations,
applying convolutions to the first upsampled representations to acquire downsampled first upsampled representations comprising the same resolution as the second upsampled representations,
applying transposed convolutions to the second upsampled representations to acquire upsampled second upsampled representations comprising the same resolution as the first upsampled representations,
applying convolutions to the second upsampled representations to acquire downsampled second upsampled representations comprising the same resolution as the third upsampled representations,
applying transposed convolutions to the third upsampled representations to acquire upsampled third upsampled representations comprising the same resolution as the second upsampled representations, determining the first output representations on the basis of superpositions of the first upsampled representations and the upsampled second upsampled representations,
determining the second output representations on the basis of superpositions of the second upsampled representations, the downsampled first upsampled representations and the upsampled third upsampled representations, and
determining the third output representations on the basis of superpositions of the third upsampled representations and the downsampled second upsampled representations.

11. Apparatus according to claim 10, wherein apparatus is configured for applying non-linear activation functions to the first, second, and third upsampled representations and to the downsampled first, upsampled second, downsampled second, and upsampled third representations.

12. Apparatus according to claim 10, wherein the transposed convolutions of the first, second and third input representations comprise an upsampling by an upsampling rate of 2 or 4.

13. Apparatus according to claim 7, wherein a number of the first input representations equals a number of the first output representations, and a number of the second input representations equals a number of the second output representations, and a number of the third input representations equals a number of the third output representations.

14. Apparatus according to claim 7, wherein each of the input representations and the output representations is a two-dimensional array of values.

15. Apparatus according to claim 7, wherein a number of the first input representations is at least one half or at least five eighths or at least three quarters of a total number of the first to third input representations.

16. Apparatus according to claim 7, wherein a number of the second input representations is at least one half or at least five eighths or at least three quarters of a total number of the second and third input representations.

17. Apparatus according to claim 7, wherein a number of the first input representations is in a range from one half to 15/16 or in a range between five eighths to seven eighths or in a range between three quarters and seven eighths of a total number of the first to third input representations.

18. Apparatus according to claim 7, wherein a number of the second input representations is in a range from one half to 15/16 or in a range between five eighths to seven eighths or in a range between three quarters and seven eighths of a total number of the second and third input representations.

19. Apparatus according to claim 7, wherein the resolution of the first input representations is twice or fourth the resolution of the second input representations, and
wherein the resolution of the second input representations is twice or fourth the resolution of the third input representations.

20. Apparatus according to claim 1, configured for determining a probability model for the entropy decoding of a currently decoded feature of the feature representation on the basis of one or more previous features of the feature representation using a further neural network.

21. Apparatus according to claim 1, configured for determining a probability model for the entropy decoding of a currently decoded feature of the feature representation on the basis of side information, which is representative of a spatial correlation of the feature representation, using a further neural network.

22. Apparatus according to claim 1, configured for determining a probability model for the entropy decoding on the basis of side information which is representative of a spatial correlation of the feature representation,
wherein the apparatus is configured for determining the probability model for the entropy decoding of a currently decoded feature of the feature representation on the basis of a first probability estimation parameter and on the basis of a second probability estimation parameter,
wherein the apparatus is configured for
determining the first probability estimation parameter on the basis of previously decoded features of the feature representation,
using a further CNN for determining the second probability estimation parameter on the basis of the side information.

23. Apparatus according to claim 22, wherein the apparatus is configured for
determining the first probability estimation parameter on the basis of previously decoded features of the feature representation using a third neural network, and
determining the probability model on the basis of the first and second probability estimation parameter using a fourth neural network.

24. Apparatus for encoding a picture, configured for
using a multi-layered convolutional neural network, CNN, for determining a feature representation of the picture,
encoding the feature representation using entropy coding, so as to acquire a binary representation of the picture,
wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.

25. Method for decoding a picture from a binary representation of the picture, the method comprising:
deriving a feature representation of the picture from the binary representation using entropy decoding,
wherein the feature representation comprises a plurality of partial representations comprising first partial representations, second partial representations and third partial representations, wherein a resolution of the first partial representations is higher than a resolution of the second partial representations, and the resolution of the second partial representations is higher than a resolution of the third partial representations, and
using a multi-layered convolutional neural network, CNN, for reconstructing the picture from the feature representation.

26. Method for encoding a picture, the method comprising:
using a multi-layered convolutional neural network, CNN, for determining a feature representation of the picture,
encoding the feature representation using entropy coding, so as to acquire a binary representation of the picture,
wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.

27. Bitstream into which a picture is encoded using an apparatus for encoding a picture, configured for
using a multi-layered convolutional neural network, CNN, for determining a feature representation of the picture,
encoding the feature representation using entropy coding, so as to acquire a binary representation of the picture,
wherein the CNN is configured for determining, on the basis of the picture, a plurality of partial representations of the feature representation comprising first partial representations, second partial representations and third partial representations, wherein a resolution of the first partial representations is higher than a resolution of the second partial representations, and the resolution of the second partial representations is higher than a resolution of the third partial representations.
